(19) United States
(12) Patent Application Publication
(10) Pub. No.: US 2004/0177326 A1
(43) Pub. Date: Sep. 9, 2004

(54) Internet/intranet software system to audit and manage compliance

(76) Inventors: Peter N. Bibko, Kenner, LA (US); John Millet, (US)

Correspondence Address: PETER N. BIBKO, 4425 RUE ST. PETER, KENNER, LA, 70065, US

(21) Appl. No.: 10/688,388

(22) Filed: Oct. 18, 2003

Related U.S. Application Data
(60) Provisional application No. 60/420,028, filed on Oct. 21, 2002.

(51) Int. Cl. G06F 17/21

(52) U.S. Cl. 715/530

(57) ABSTRACT

A comprehensive WWW based system for identifying, auditing, and confirming on-going compliance with certain regulatory requirements applicable to a plurality of U.S. industrial, manufacturing, commercial and retail facilities. Requirements applicable to each type of facility are predetermined using state and federal government web sites and, incorporated into electronic “C-Records”. Facility managers complete “facility profiles” to identify specific C-Records applicable to facilities and download and assign C-Records to employees and contractors for completion. C-Records are accessed via the WWW for completion and used to audit past compliance and to periodically confirm on-going compliance thereafter. Managers revise profiles as necessary to reflect changes in operation, and the invention automatically directs responsible employees and contractors to complete additional C-Records, if required. Authorized users monitor compliance by all employees or contractors, or at all facilities, via the WWW, at any time.

### CROSS-REFERENCE TO RELATED APPLICATION

U.S. Provisional Application Serial No. 60/420,028. This application, originally filed on or before Oct. 21, 2003 is based on U.S. Provisional Application Serial No. 60/420,028 filed on Oct. 21, 2002. The inventors claimed the benefit of Title 35, Section 119 of the U.S. Code based on said provisional application. An amendment to the application was filed on or before Mar. 10, 2004.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### I. BACKGROUND OF THE INVENTION

A. Field of the Invention

The invention involves computer and Internet based software designed to assist specific types of users in identifying, complying and monitoring on-going compliance with government regulations, via the World Wide Web (“WWW”).

B. State of the Art

Prior to the present invention regulated entities operating in the United States could not effectively and efficiently attain and maintain compliance with regulations promulgated by regulatory agencies because: Applicable requirements could not be easily and economically identified and understood by personnel assigned compliance responsibilities at each entity or “facility”; Management could not efficiently assign compliance responsibilities to various appropriate individuals serving at each facility, and; Management could not efficiently monitor on-going compliance status thereafter.

Although compliance needs vary depending upon the particular regulations and facilities involved, the advancement of the invention over the prior art may be exemplified by considering compliance with environmental regulations, for example, at various types of facilities, which is presented in considerable detail below.

However, anyone reasonably well schooled in the art will understand that the following discussion may be equally applicable to the compliance needs applicable to a plurality of other regulations and regulatory requirements as further set forth herein.

### 1. SUMMARY OF THE PROBLEM

a. “Minor facility” Compliance Problems

Various commercial and retail facilities, staffed by relatively few personnel, such as convenience stores and dry cleaners, or “minor facilities”, have historically found it difficult to comply with state and federal regulations, including environmental regulations.

By way of example, Louisiana Department of Environmental Quality (“LDEQ”) enforcement records for the 3^{rd} Quarter of 2001, show that 28% of the 250 enforcement actions filed by LDEQ were for violations by small automotive-related businesses, and about 50% of all violations were by various types of small businesses. (LDEQ web site, Enforcement Summary). This poor compliance record results in no small part, because these facilities have had great difficulty in identifying and understanding applicable requirements, and in regularly confirming on-going compliance with applicable requirements at their facilities.

Prior to the instant invention, methods had not been disclosed for allowing management of minor facilities to economically and directly identify applicable requirements; communicate requirements to employees and contractors responsible for complying at various geographically dispersed facilities, prompt employees and contractors when it was time to comply, and periodically monitor to confirm on-going compliance thereafter, via the WWW.

b. “Major Facility” Compliance Problems

Other types of larger manufacturing and industrial facilities such as steel mills, power plants and petrochemical facilities, or “major facilities”, were faced with very different compliance problems. They historically found it difficult to comply with state and federal regulatory reporting requirements applicable to all major facilities. Unfortunately for reasons set forth in more detail below, this poor compliance record resulted primarily because management of these facilities had great difficulty in monitoring timely and on-going compliance with reporting requirements.

Prior to the instant invention, methods had not been disclosed for allowing management of major facilities to reliably and efficiently monitor and track compliance status among various geographically dispersed facilities, sufficient to assure on-going compliance with general reporting requirements, via the WWW.

c. Regulatory Agency Compliance Problems

Prior to the instant invention government regulatory agencies historically found it difficult to cost-effectively audit or inspect compliance with applicable requirements by various geographically dispersed minor facilities, and/or reporting requirements, by major facilities.

Prior to the instant invention, inspection and auditing of various numerous minor facilities required agencies to divert scarce enforcement resources away from major facilities, where often needed the most.

Prior to the instant invention, methodologies had not been disclosed for allowing government regulatory agencies to efficiently and economically monitor compliance with applicable requirements by minor facilities and/or compliance with reporting requirements by major facilities, via the WWW.

2. Identifying Applicable Requirements at Minor Facilities

Employees and contractors at minor facilities have long been required to identify diverse government regulations, including for example, environmental regulations, health and safety regulations, securities regulations, customs and immigration regulations, communicable disease reporting regulations, etc., that apply to their facilities.

Prior to the instant invention, those reasonably well schooled in the art, including lawyers, and various regulatory consultants for example, understood that all federal regulations were codified and readily available in electronic format in the U.S Code of Federal Regulations (“CFR”), via the WWW, and that all state regulations were codified and available as electronic documents in various state codes, via the WWW.

By way of example, all environmental regulations promulgated by the U.S. EPA were known to be located within Title 40 of the CFR and available via the WWW; all health and safety regulations promulgated by the U.S. Occupational Safety and Health Administration were known to be located within the CFR under Title 29, and available via the WWW; all health and safety regulations promulgated by the U.S. Mine Safety and Health Administration were known to be located within the CFR under Title 29 and available via the WWW, and; all securities regulations promulgated by the U.S. Securities and Exchange Commission were known to be located within the CFR under Title 17, and available via the WWW.

The problem confronting many minor facilities was not, however, in accessing all state and federal regulations potentially applicable to a particular facility, but rather, in committing the financial resources needed to identify and separate those relatively few regulations or “applicable requirements” that applied to various minor facilities from the very large number regulations that did not.

Anyone reasonably well schooled in the art understands that by their very nature, most if not all regulations are complex and difficult to understand by most laymen:

“The ultimate hardship that is faced by the self-employed and micro-businesses when dealing with federal agencies is the complexity and vagueness of regulations they issue. The simple difficulty of understanding and then complying with any and all regulations affecting their business is overwhelming for a micro-business owner.” (Darien, K, 2003)

This complexity often made it necessary for management of minor facilities to retain the services of lawyers and other professionals at substantial cost:

A report sponsored by the U.S. Small Business Administration entitled “The Impact of Regulatory Costs on Small Firms,” cited that firms employing fewer than 20 employees face an annual regulatory burden of $6,975 per employee. This same report cited that environmental regulations and tax compliance issues are particularly burdensome to small business. (Darien, K, 2003)

Most minor facilities did not have the financial resources needed to retain trained lawyers and other professionals, needed to identify applicable requirements on a case by case basis:

“This burden imposed on microbusiness is disproportionate to that of larger businesses because smaller firms cannot spread the overhead costs associated with hiring accountants and attorneys, and the general cost of paperwork burdens and staff needed to try and comply with the maze of federal regulatons.” (Darien, K, 2003)

Compliance assistance services offered by various government agencies, though increasingly available, fell short of intended goals primarily because of the widespread reluctance of many minor facility owners to voluntarily share their compliance problems with state and federal regulators:

“Many [small businesses] in general do not feel comfortable with calling the various federal agencies to ask questions and seek compliance assistance.” (Darien, K, 2003)

Similarly, summaries of regulatory requirements published by various regulatory agencies were largely ineffective because users could not dedicate the time needed to read and review information as required to identify the specific applicable requirements for each facility:

“EPA, OSHA and other Federal agencies are making good faith efforts to assist small businesses in understanding and complying with regulations. These agencies are publishing more “plain English” guidance and other documents to simplify what I need to know about compliance. . . . However, despite such compliance assistance, it still remains necessary to read the rules in their entirety.” (Thomas, D, 2000)

Various forms and checklists, such as for example, those which had been published by the National Convenience Store Association in the “Petroleum Marketers Book of Federal Compliance Forms”, also proved ineffective because users could not dedicate the time needed to read and review information as required to separate out forms that were applicable from those which were not:

“[T]o fully understand and property fill out these forms, one must read hundreds of pages of supporting material.” (Thomas, D, 2000)

Nor had the prior art disclosed systems for allowing managers of minor facilities to reliably and economically generate the records needed to efficiently comply with applicable requirements and to periodically confirm ongoing facility compliance thereafter:

“When I began my [convenience store] company in 1994, I filled out all of the necessary paperwork myself or in-house. Since that time, my store managers spend an additional two hours per week filling out paper work. I also have been forced to hire an outside firm to assist Q-Markets with its record keeping at an annual cost of $3,000 per store.” (Thomas, D, 2000)

Therefore, what was clearly not well known or understood before the present invention, was that all of these compliance problems could have been avoided entirely by predetermining and incorporating all possible regulatory requirements applicable to each of various types of minor facilities into a series of individual documents, and identifying specific documents applicable to each facility based upon unique operating characteristics of each facility as indicated by each facility manager, via the WWW, and without need for site specific legal assistance.

2. Monitoring Reporting Activities by Major Facilities

Anyone reasonably well schooled in the art understands that all major facilities may be subject to the same general requirement to file a report, while the particular content of reports may vary widely, depending upon highly variable site specific factors.

Anyone reasonably well schooled in the art understands, for example, that the U.S. EPA and LDEQ have promulgated environmental reporting requirements generally applicable to all types of industrial and/or manufacturing major facilities operating throughout the United States, including power plants, shoe factories, and petrochemical facilities, for example.

Anyone reasonably well schooled in the art will also understand that unlike applicable requirements for minor facilities, details of information required to be reported cannot be ascertained directly from either the CFR or state codes because dependent upon a myriad of permit and site specific variables and requirements, not set forth in either the CFR or state codes.

Examples of such environmental reporting requirements applicable to all major facilities, include: annual reporting of amounts of hazardous substances kept on site under SARA 312; requirements to report and provide new “MSDS's” for new hazardous substances brought on site every 3 months under SARA 311; requirements to periodically file discharge monitoring reports Clean Water Act; requirement to file semi-annual, quarterly, and annual reports confirming compliance with Clean Air Act “Title V” certification requirements, and requirements to report amount of hazardous waste disposed of annually under RCRA reporting requirements.

Anyone reasonably well schooled in the art will also understand that the sheer number of reports to be submitted to regulatory agencies made it particularly difficult for owners/operators of geographically dispersed major facilities to monitor to confirm timely and proper reporting at all facilities.

Therefore, what was clearly not well known or understood before the present invention, was that all of these compliance problems could have been avoided entirely by predetermining and incorporating all possible regulatory reporting requirements applicable to all types of major facilities (irrespective of type) into a series of individual documents, and identifying specific documents applicable to each facility based upon input from each facility manager, via the WWW, and without need for site specific legal assistance.

3. Detailed Review of the Prior Patent Art

The prior art all but ignored the compliance needs of minor facilities, by focusing almost entirely on providing systems to better allow major facilities more efficiently assimilate and analyze compliance data and information collected at a facility site, as needed to generate reports required by statute or permit to be submitted to a regulatory agency.

Without exception, all prior art simply assumed that all applicable requirements and reporting requirements would be otherwise determined through traditional means (i.e. use of lawyers and consultants) by minor and major facilities, respectfully.

For example, U.S. Patent App.20030065690 described a method to help facilitate compliance with certain specific reporting requirements, applicable to major facilities, without disclosing either means to identify reporting requirements applicable to a major facility or means to monitor and assure on-going compliance.

Similarly, U.S. Patent App. 20030065690 disclosed a method for allowing an individual facility to certify facility compliance with details of known site specific permitting requirements applicable to major facilities.

The prior art had disclosed methods to signal non-compliance with known requirements, applicable to any type of facility, but without disclosing any means or methods to help identify the applicable requirements, or reporting requirements with which either minor facilities or major facilities had to comply.

For example, U.S. Pat. No. 5,623,403 disclosed a computerized “rule application system” for identifying non-compliance with certain known and specific motor vehicle registration laws, identified by the “government.” (emphasis added).

Similarly, U.S. Pat. No. 6,163,732 disclosed a computer system and method for determining compliance of a chemical product with certain known and specified government regulations applying to the product. The composition of a chemical being compared by the computer system to was compared to a stored set of government regulation standards and flagged as either complying or non-complying.

Once again, U.S. Patent App. 20030153991 relied on essentially the same “computer rule application” system, as in '403, but in addition, purported to disclose a method for managing compliance with all of “rules” applicable to all facilities, without actually disclosing any method for identifying the applicable requirements.

In seeking to distinguish '991 from the prior art ('403), the inventor stated in relevant part:

“Despite these automated rule application systems, [in '403] there is still a need for a system that can address all of an entity's concerns, regarding compliance management, including: making an entity aware of the rules.” (emphasis added) [see '991 at 0015]

Therefore, while recognizing the critical importance of “rule identification”, the “rule database”, included in '991, (purportedly to identify all rules “prescribed by legislation and regulations” [at 0047] and to make the user “aware of the rules”,—simply did not!

Rather as shown in '991 at [0050]), the inventor avoided discussion and disclosure of a rule identification system, by simply stating that “various rule application systems are known to those skilled in the art, and will not be reiterated here.” [See '991 at 0061]

By way of summary, U.S. patent art reviewed, included: U.S. Patent App. 20020023109 (“MSDS” requirements and shipping regulations); U.S. Patent App. 20020120642 (“legislative obligations”); U.S. Patent App.20030065690 (certain specific regulatory agency industrial air emission reporting requirements); U.S. Patent App. 20030069894 (computer reliability requirements); U.S. Patent App. 20020138574 (non-regulatory “standard, process or procedure”); U.S. Patent App. 20020194014 (risk based management system testing); U.S. Patent App. 20030065690 (regulatory reporting requirements); U.S. Patent App. 20030065690 (computer reliability requirements); U.S. Patent App. 20030083916 (contractual compliance requirements); U.S. Patent App. 20030120528 (supply chain management); U.S. Patent App. 20030065690(Compliance systems designed to serve needs of a particular industry); U.S. Pat. No. 6,449,598 (determination of whether or not employees read applicable policy requirements); U.S. Pat. No. 6,490,565; U.S. Pat. No. 5,897,619, U.S. Pat. No. 4,803,039, U.S. Pat. No. 5,664,112 and U.S. Pat. No. 5,726,884 (compliance with specific reports or environmental certifications); U.S. Pat. No. 6,151,586 (compliance with health plan requirements); U.S. Pat. No. 6,351,689 and 6,546,314 (polling remote locations for compliance data);

### IN CONCLUSION

The prior art had not disclosed a WWW based method for allowing an authorized representative of a minor facility and/or major facility to directly identify all applicable state and federal requirements, and reporting requirements, respectively, via the WWW, and without need for site specific legal assistance.

The prior art had not disclosed a WWW based method for allowing an authorized representative of a minor facility and/or major facility to directly audit past compliance with all applicable requirements and/or reporting requirements, respectively, via the WWW, and without need for site specific legal assistance.

The prior art had not disdosed a WWW based method for allowing an authorized representative of a minor facility and/or major facility to understand and comply with all applicable requirements and/or reporting requirements, respectively, via the WWW, and without need for site specific legal assistance.

The prior art had not disdosed a WWW based method for allowing an authorized representative of a minor facility and/or major facility to directly and periodically monitor or confirm on-going compliance with all applicable requirements and/or reporting requirements, respectively, via the WWW, and without need for site specific legal assistance.

The prior art had not disclosed a WWW based method for allowing an authorized representative of a regulatory agency to directly and periodically monitor or confirm on-going compliance with all applicable requirements and/or reporting requirements, by minor facilities and/or major facilities, respectively, via the WWW, and without need for site specific legal assistance.

### II. BRIEF SUMMARY OF THE INVENTION

The present invention overcomes the previously enumerated regulatory compliance problems faced by minor facilities in the past, by providing: (a) a method for efficiently identifying all state and federal regulatory requirements applicable to a minor facility; (b) systems to train personnel, facilitate recordkeeping, prompt compliance, and audit compliance with applicable requirements, and; (c) systems to facilitate and help assure on-going compliance with applicable requirements thereafter.

This application is rooted in the previously undisclosed understanding that: all state and federal regulatory requirements potentially applicable to all minor facilities (of the same type) may be directly predetermined en total, by a lawyer or other qualified professional, from the U.S. Code of Federal Regulations (“CFR”) and corresponding state codes, via the WWW (without need to consider any facility specific requirements) and: by predetermined and linking all possible regulatory requirements (that could be potentially applicable to all minor facilities) to various specific operating activities undertaken at any or all facilities, and then by directing managers at each facility to identify specific activities undertaken at each facility and thereby identify requirements applicable to each facility. Once identified, such requirements may be directly accessed and used by an authorized representative of a minor facility to identify and download all specific requirements applicable to any particular facility.

The present invention also overcomes compliance problems faced by major facilities in the past, by providing: (a) a method to identify all reporting requirements potentially applicable to major facilities; b) systems to train personnel, facilitate recordkeeping, prompt compliance, and audit compliance with reporting requirements, and; (c) systems to facilitate and help assure on-going compliance with reporting requirements thereafter. Once identified, such requirements may be directly accessed and used by an authorized representative of a major facility to identify and download all specific requirements applicable to any particular facility.

This application is rooted in the previously undisclosed understanding that: All reporting requirements potentially applicable to all major facilities may be predetermined, and, then managers of each major facility may be directed to select groups of requirements applicable to specific facilities (along with associated C-Records) based upon specific operating activities at each facility.

The present invention also overcomes compliance auditing and inspection problems faced by regulatory agencies, in the past, by providing: (a) a method for allowing authorized representatives of a regulatory agency to efficiently confirm compliance with applicable requirements by all minor facilities, via the WWW, (b) a method for allowing agency representatives to efficiently identify all minor facilities and/or major facilities, that have failed to confirm full compliance, and; (c) a method for prioritizing and directing scarce enforcement resources to facilities failing to confirm compliance while limiting inspection of those that confirm full compliance.

This application is rooted in the previously undisclosed understanding that: all state and federal regulatory requirements potentially applicable to all minor facilities (of the same type) may be directly predetermined en total, by regulated facilities themselves, directly from the U.S. Code of Federal Regulations (“CFR”) and corresponding state codes, via the WWW (without need for additional agency involvement) and: by predetermining, and linking all possible regulatory requirements (that could be potentially applicable to all minor facilities) to various specific operating activities undertaken at any or all facilities, and then by directing managers at each facility to identify specific activities undertaken at each facility and thereby identify requirements applicable to each facility. Once identified, all applicable requirements could be incorporated into individual electronic C-Records and distributed for use among various employees and contractors serving each facility, to easily identify applicable requirements and help assure on-going compliance, via the WWW, and without need for site specific additional legal assistance. If and when authorized by law or consent of a regulated entity, the regulatory agency might then efficiently and economically periodically monitor for ongoing compliance at both minor and major facilities, via the WWW.

By way of summary, the application and workings of the invention may be summarized as follows:

All requirements applicable to minor facilities as well as reporting requirements applicable to major facilities may be identified from state and federal regulatory web sites, electronically copied, and incorporated into electronic documents, that may be conveniently referred to as “C-Records”, with each addressing various groupings of applicable requirements and/or reporting requirements.

C-Records addressing applicable requirements (minor facilities) and reporting requirements (major facilities) may be conveniently formatted so as to allow the user to confirm full compliance with applicable requirements and/or reporting requirements.

Managers of both minor facilities and/or major facilities may be directed to sign onto a WWW web site to complete a “facility profile” and thereby identify and download specific C-Records for subsequent completion by various responsible employees and/or contractors serving each facility.

Responsible employees and/or contractors may likewise subsequently access C-Records via the WWW, audit for past compliance; comply with applicable requirements during on-going operations, and; periodically confirm on-going compliance thereafter.

The system might also be easily configured to provide compliance assistance documents including various electronic forms, data logs, letters, etc., as needed to assist those serving in responsible positions to comply with applicable requirements and reporting requirements.

Thereafter, notification to comply and periodic confirm on-going compliance may be regularly scheduled depending upon regulatory requirements (i.e. every calendar quarter) or triggered by occurrences or non-occurrences, depending on the particular facts involved. (i.e. delivery of fuel or accidental fuel spill at a facility). Additionally, the system may be easily configured to alert responsible employees and/or contractors when scheduled or unscheduled compliance is due and if and when significant changes in facility operation have triggered new compliance, and therefore new C-Record completion responsibilities. (i.e. installation of a new piece of equipment triggering new design confirmation requirements)

The system might also easily be configured to maintain results of all initial and periodic audits or confirmations in a central database, either on a facility computer, or on a provider's server, and formatted to facilitate auditing by a user and as well as monitoring of initial audit and/or monitoring of on-going compliance status.

The system might also be easily be configured to allow each facility manager to periodically confirm full compliance with applicable requirements (minor facility) and/or reporting requirements (reporting requirements) to a regulatory agency via the WWW, and/or to allow an authorized regulatory agency representative, access to verify the existence of written records needed to substantiate the certification made by the facility manager, via the WWW.

The system might also be easily configured to allow various authorized attorneys and law firms, retained by a facility to conduct regulatory compliance audits for all facilities, via the WWW, at any time.

The system might also be easily configured to allow various authorized banks and/or insurance company used by a facility to access and view screens showing the compliance status of any or all employees and/or contractors for all facilities, via the WWW, at any time.

The system might also be easily configured to allow an authorized system administrator, reasonably well schooled in the art, (whether a lawyer, law firm, or consultant), to periodically access state and federal codes of regulations via the WWW and modify or change applicable requirements and/or reporting requirements in C-Records as needed, via the WWW, at any time.

### III DETAILED DESCRIPTION OF THE FIGURES AND THE PREFERRED EMBODIMENTS OF THE INVENTION

The present invention now is described more fully hereinafter with reference to the accompanying drawings or figures, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

A. Identification of Requirements and C-Records Applicable to Minor and Major Facilities

It is a primary objective of the instant invention to disclose a method for allowing an employee or contractor serving at a minor facility to accurately and efficiently directly identify all regulatory requirements applicable to a minor facility, including for example, environmental requirements, via the WWW without need for expert assistance, and once accomplished to incorporate such regulations into a plurality of different C-Records, to be made available and used to audit and thereafter to prompt compliance and assure ongoing compliance with applicable requirements.

It is also a primary objective of the instant invention to disclose a method for allowing an employee or contractor serving at a major facility to accurately and efficiently identify all regulatory reporting requirements applicable to a facility, via the WWW without need for expert assistance, and once accomplished to incorporate such regulations into a plurality of different C-Records, to be made available and used to audit and thereafter to prompt compliance and assure on-going compliance with reporting requirements.

It is a primary objective of the instant invention to disclose a method for allowing an employee or contractor serving at a minor facility to accurately and efficiently directly identify all regulatory requirements applicable to a minor facility, including for example, environmental requirements, via the WWW without need for expert assistance, and once accomplished to incorporate such regulations into a plurality of different C-Records, to be made available and used to audit and thereafter to prompt compliance and assure on-going compliance with applicable requirements, and to allow and authorized regulatory agency representative to monitor on-going compliance at any and all such facilities.

1. Development of Templates

It is a preferred embodiment of the present invention to develop a series of “master templates” with each addressing all state and federal regulatory requirements promulgated by any single U.S. state and/or federal agency, (i.e. U.S. EPA, OSHA, SEC) applicable to a plurality of minor facilities, as well as reporting requirements applicable to a plurality of major facilities.

It is also a preferred embodiment of the present invention that templates be strictly limited in applicability to those minor and major facilities, for which all state and federal applicable requirements and/or reporting requirements, respectively, may be identified and determined directly from the CFR and state administrative codes, without reference to any permitting or other site specific variables.

According to the invention, and by reference to FIG. 11, appropriate sections of the Title 40 of the CFR (17) and Louisiana Administrative Code or any other state code, (18) may be accessed and reviewed and all groupings of state and federal environmental regulatory requirements promulgated by a plurality of different agencies, (in this case, environmental regulations) may be identified and incorporated into templates setting forth all potentially applicable requirements promulgated by each specific regulatory agency for each type of minor facility. (19)

It should be well known to those reasonably well schooled in the art that the same types or groupings of regulations may be applicable to more than one type of minor facility. For example, state and federal underground storage tank (“UST”) regulations would be equally applicable to various diverse minor facilities such as gas stations or convenience stores storing fuel in UST's; dry cleaners storing cleaning chemicals in UST's or; hospitals storing heating oil in UST's.

One reasonably well schooled in the art will also recognize that an entire chapter section title or sub-title of the CFR or state code containing applicable requirements, may be electronically copied directly from federal and state databases, and used for the purposes of creating individual draft C-Records, with each addressing a portion or subset of all applicable requirements in the chapter section title or sub-title. For example, and with reference to FIG. 1, one or more individual C-Records might be drafted for each of the following groupings of UST regulations: UST Design (11), UST Operation (12), UST Monitoring (13) and UST Reporting (14).

FIG. 1 shows one such possible master template identifying groupings and sub-groupings of specific environmental regulations promulgated by the U.S. EPA, that address all of environmental requirements promulgated by the U.S.EPA and state agency applicable to various minor facilities, including, for example: automobile dealerships; chiropractor, physician and dental offices; hospitals; paint and body shops; motor vehicle air conditioner shops, tire shops; dry cleaners; airport passenger and baggage screening operations, and convenience store or gas stations.

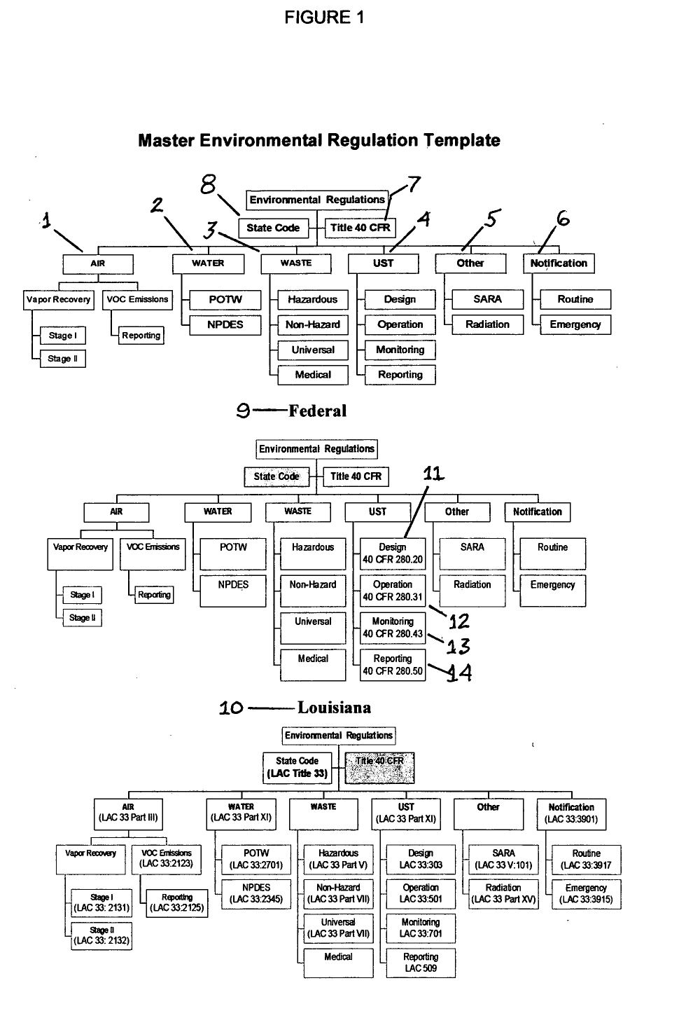

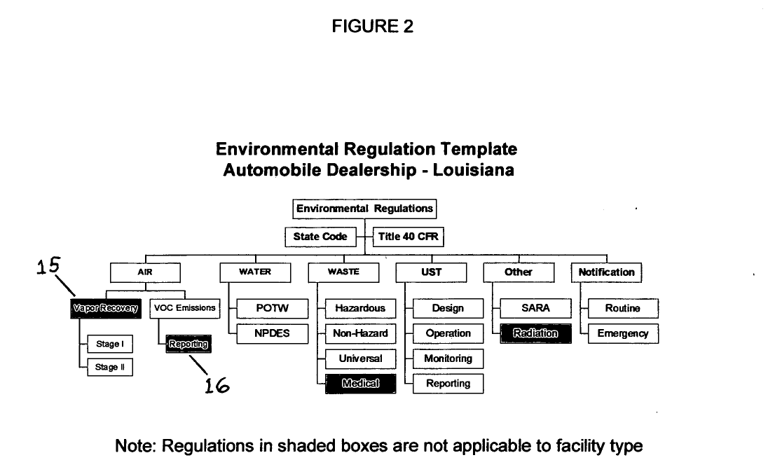

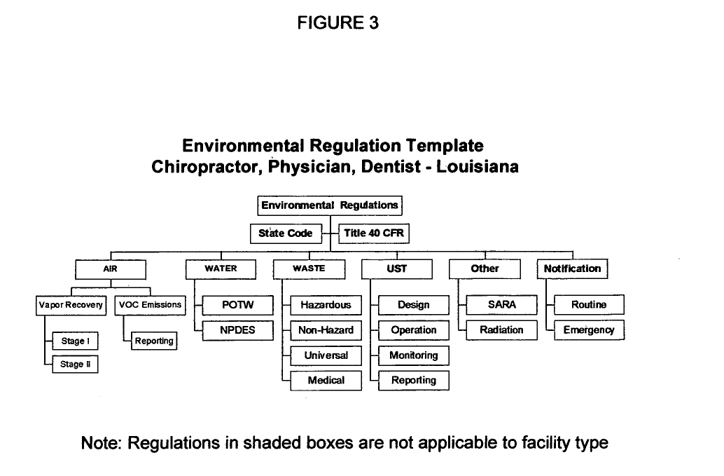

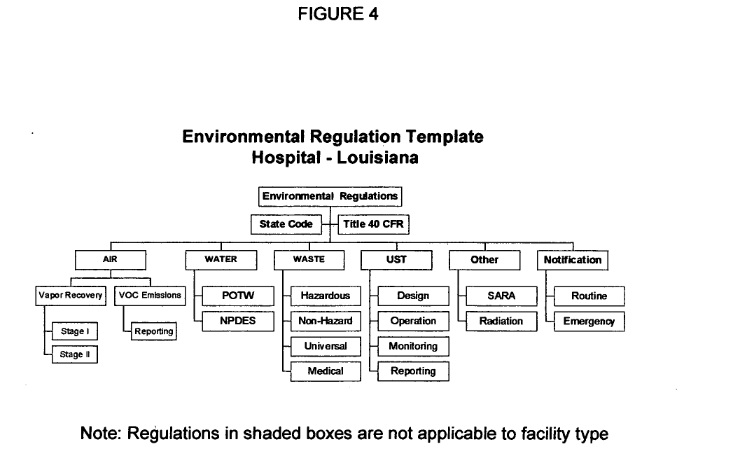

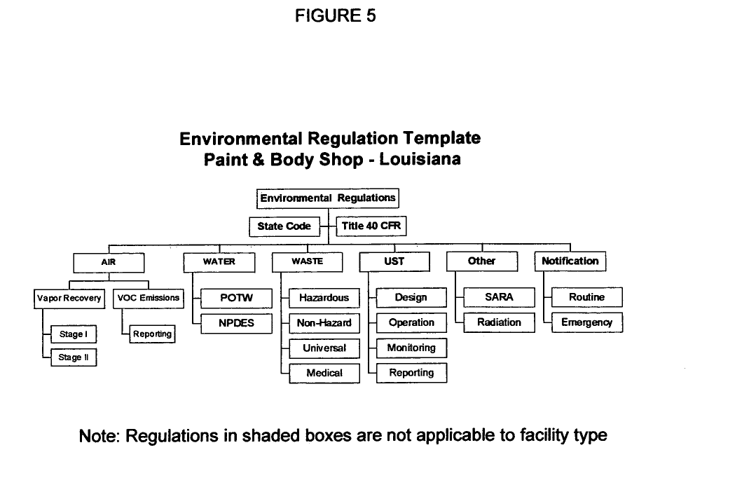

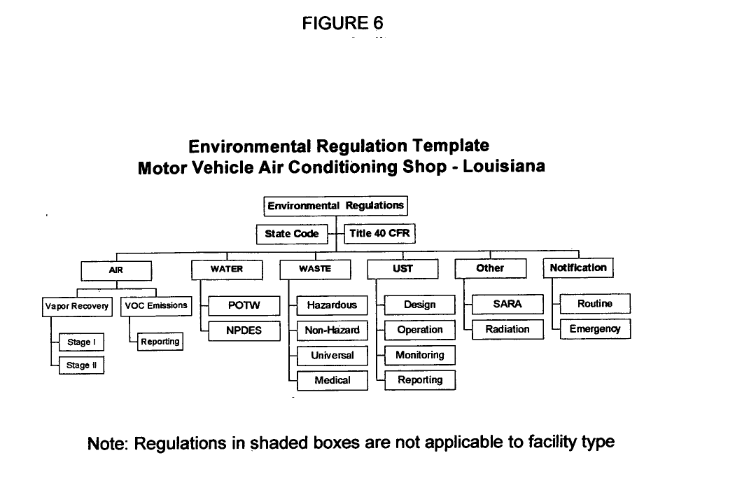

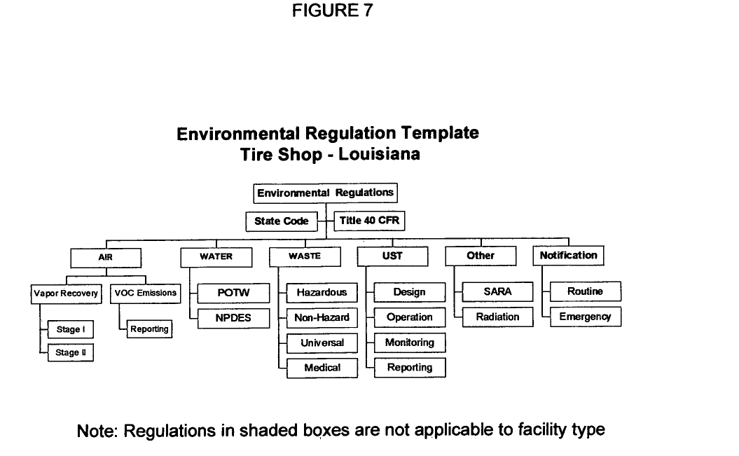

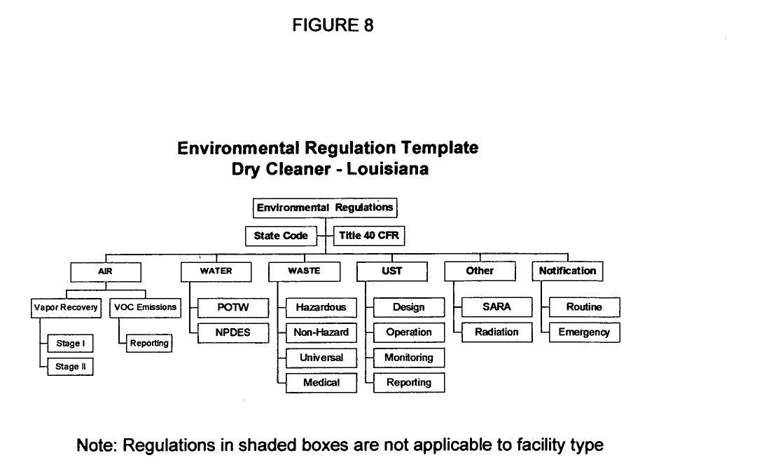

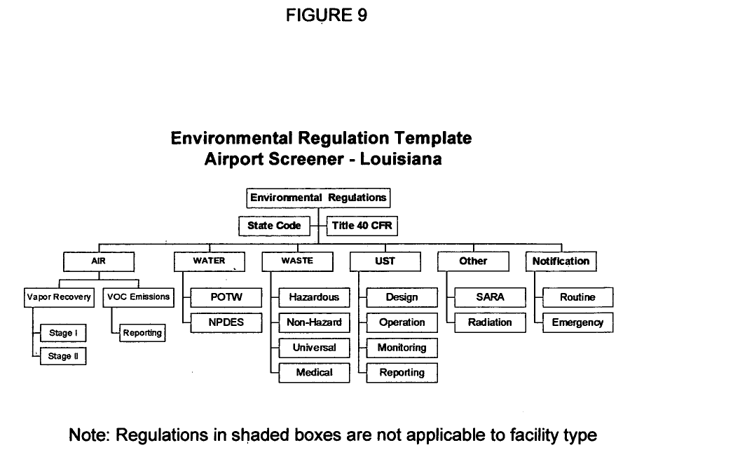

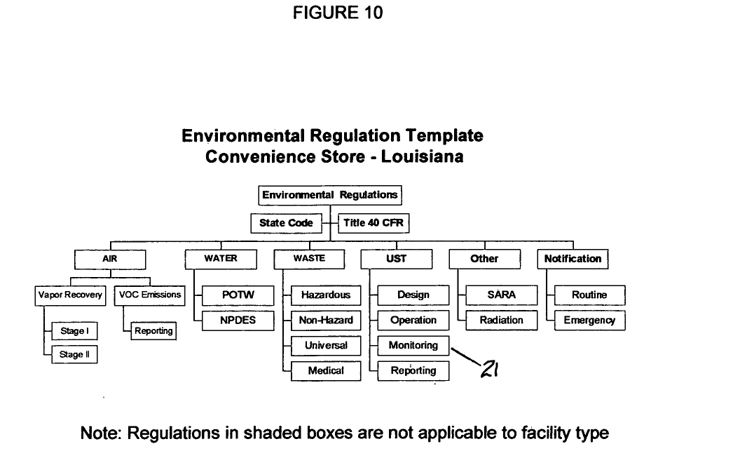

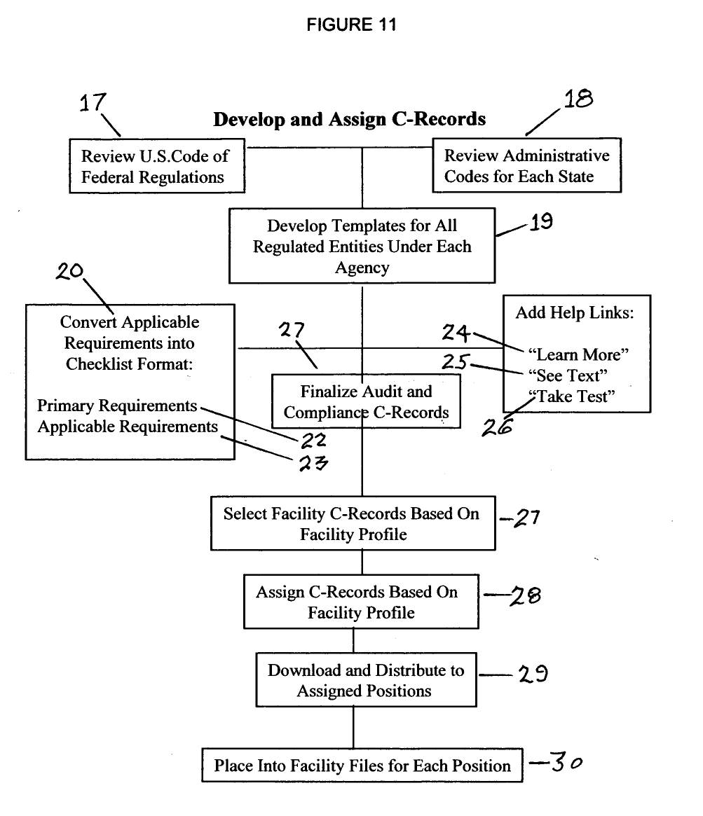

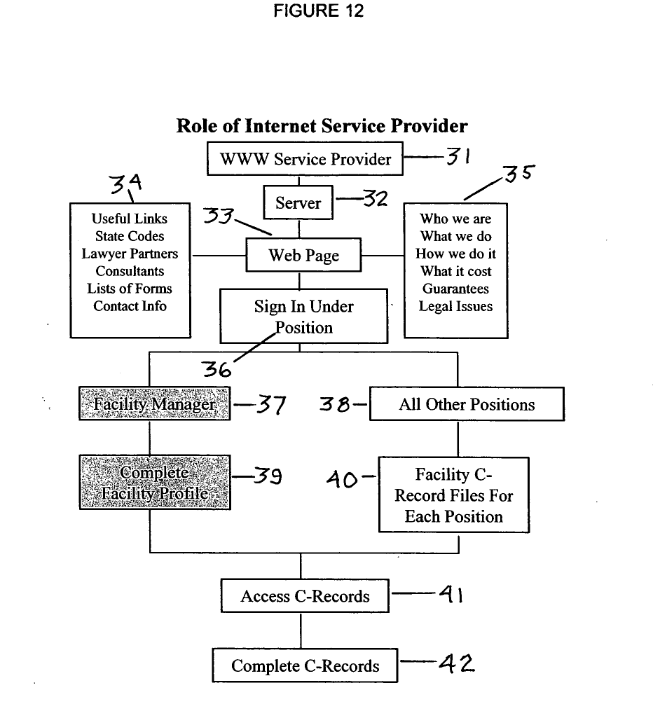

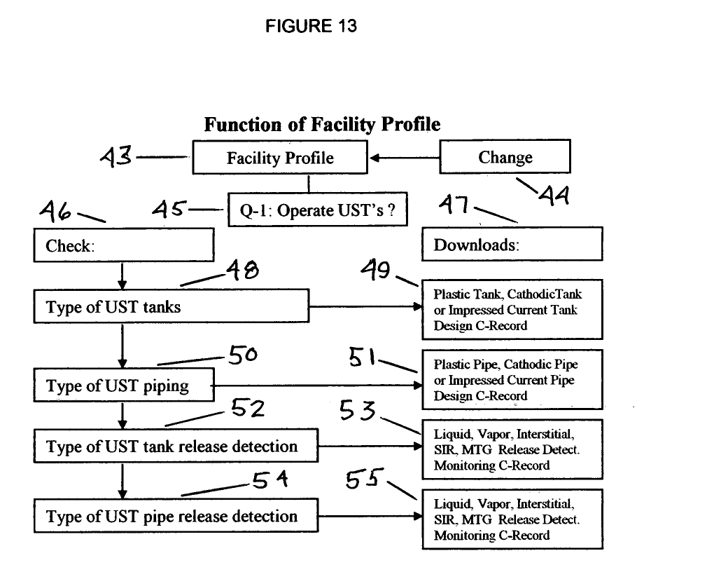

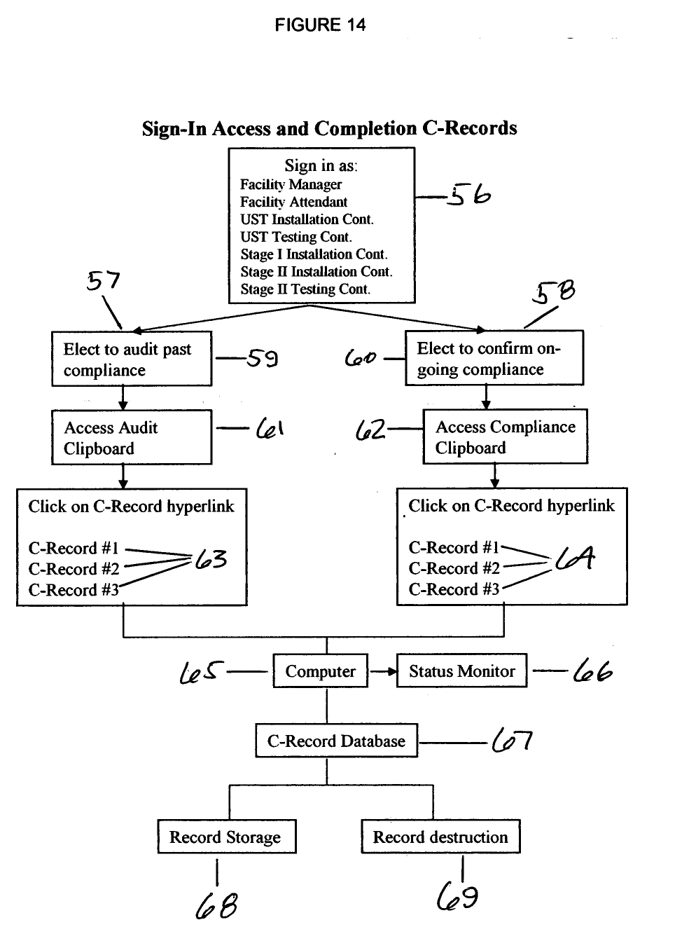

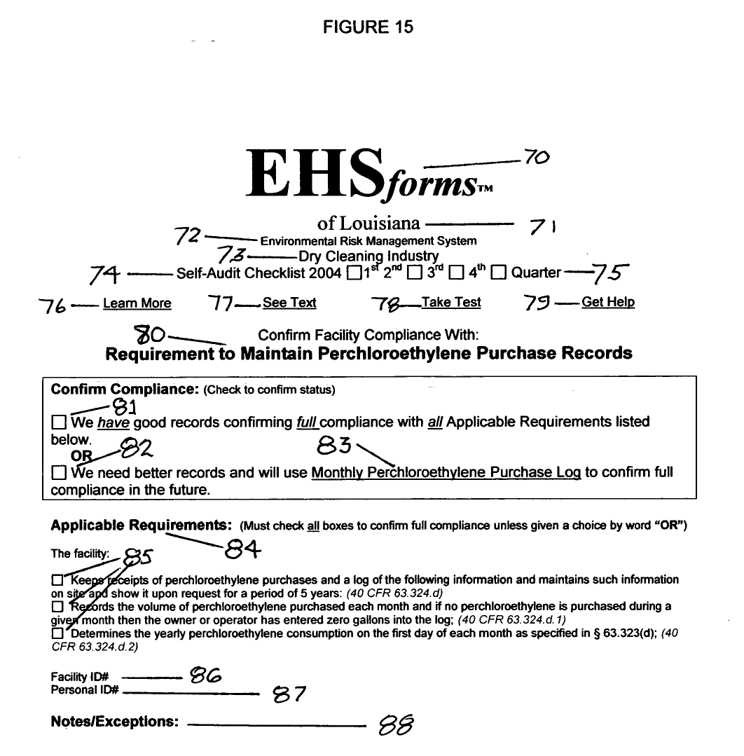

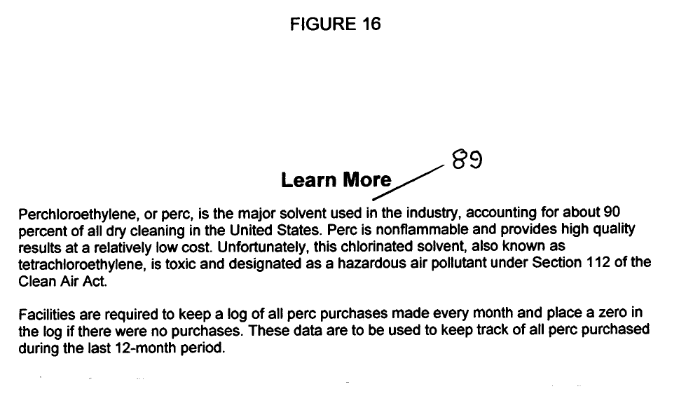

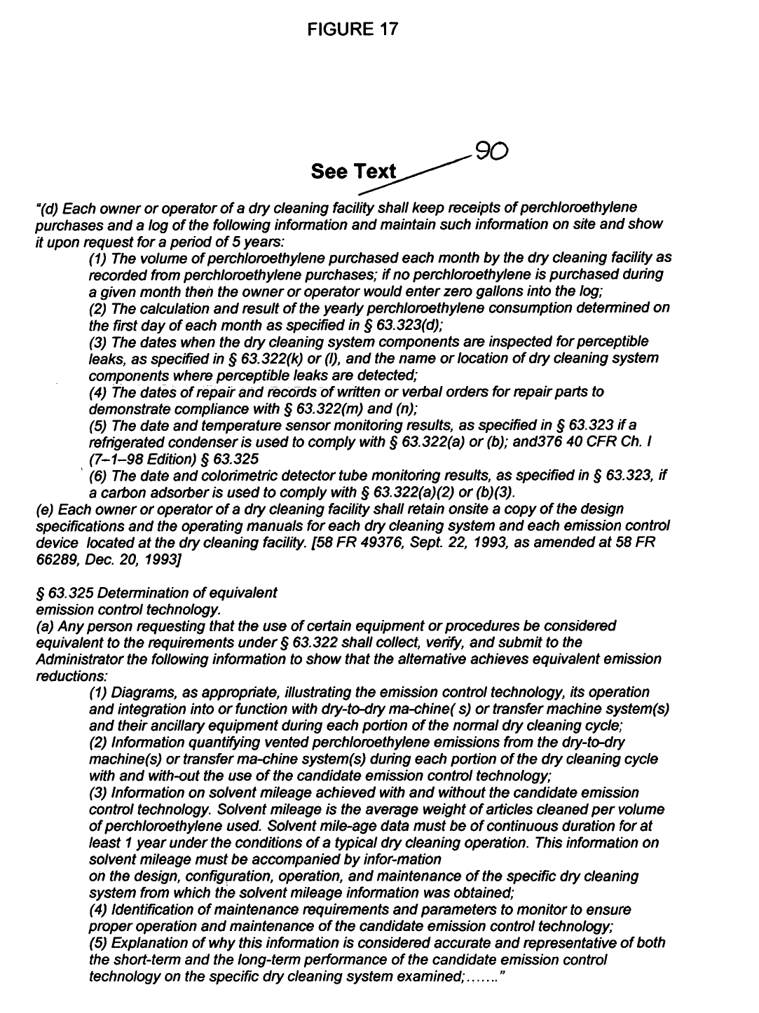

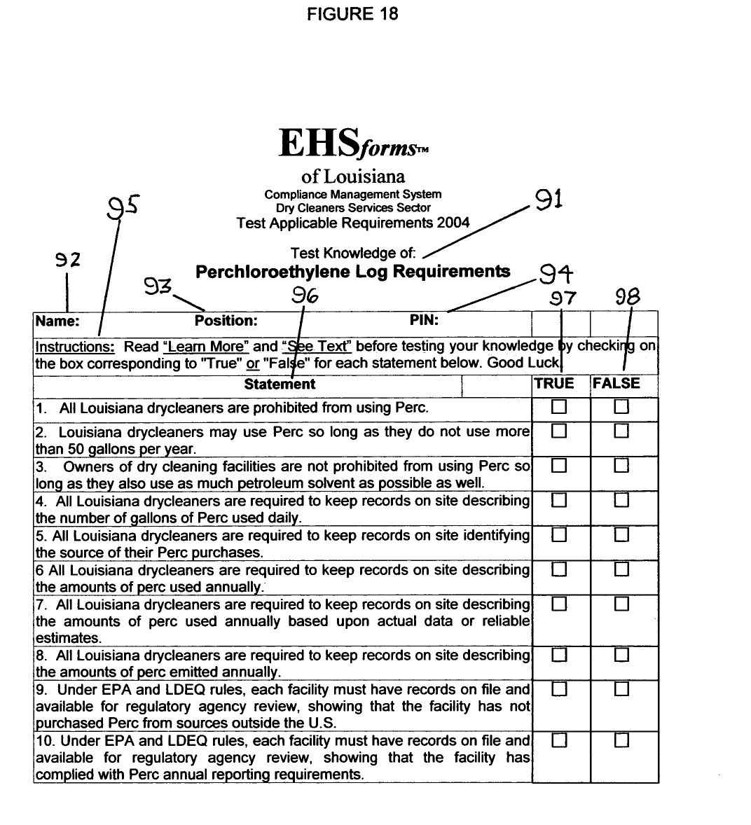

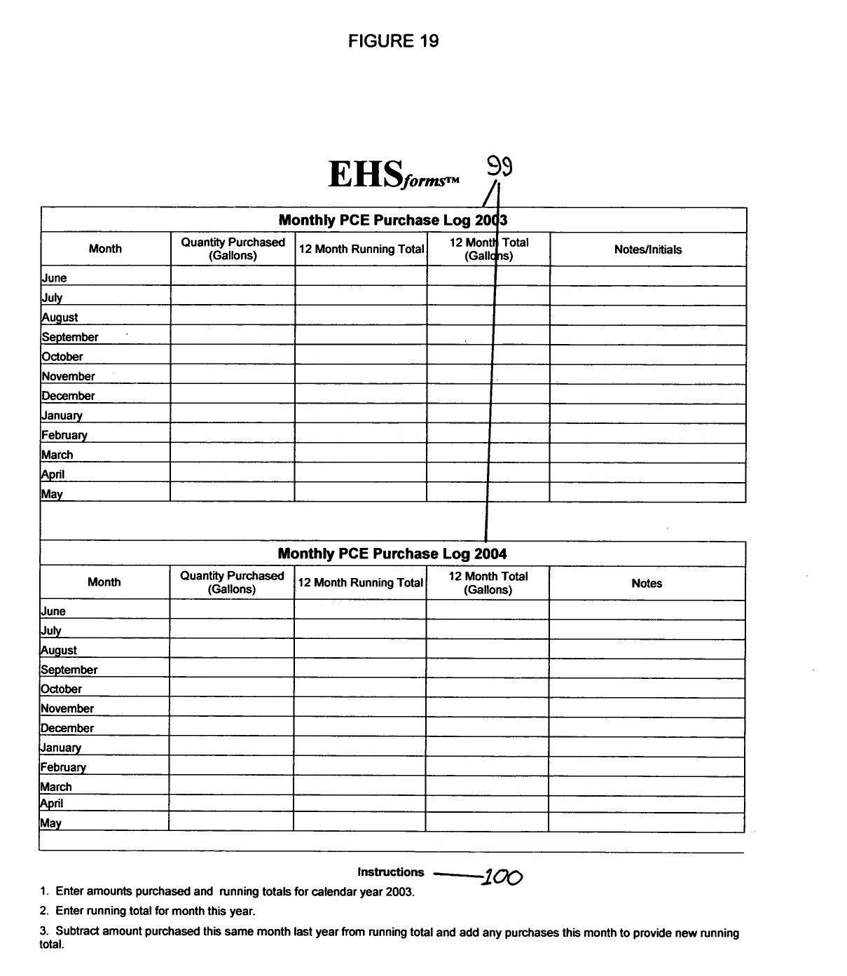

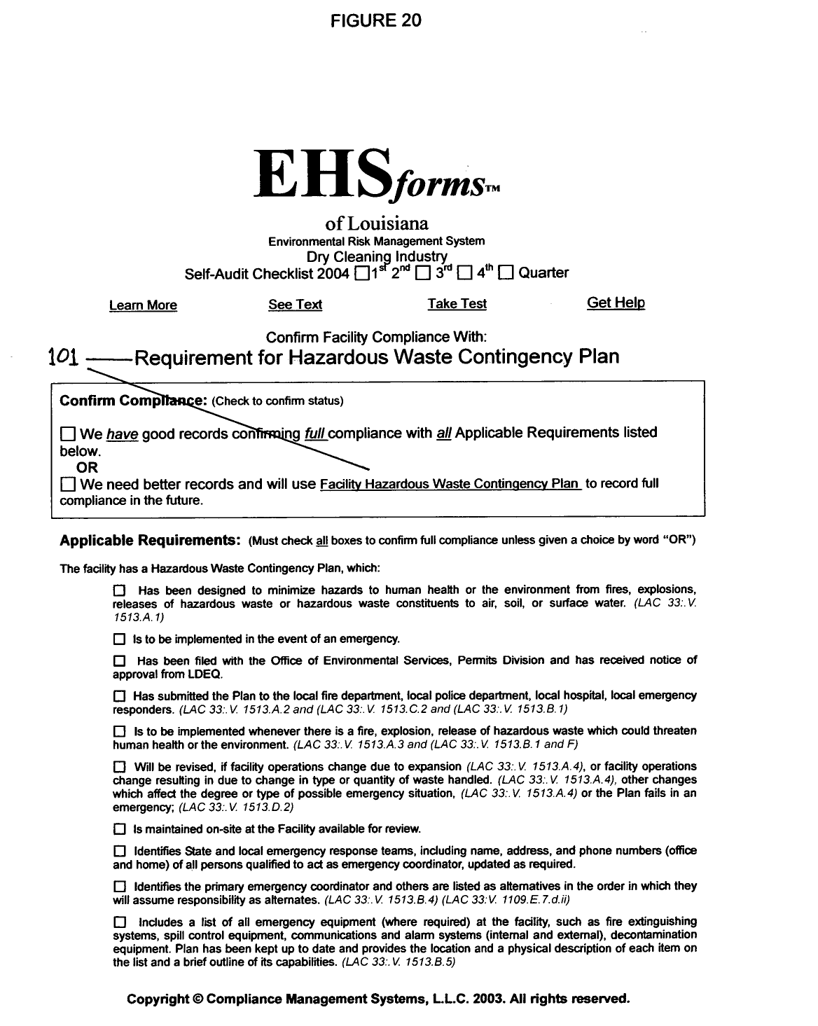

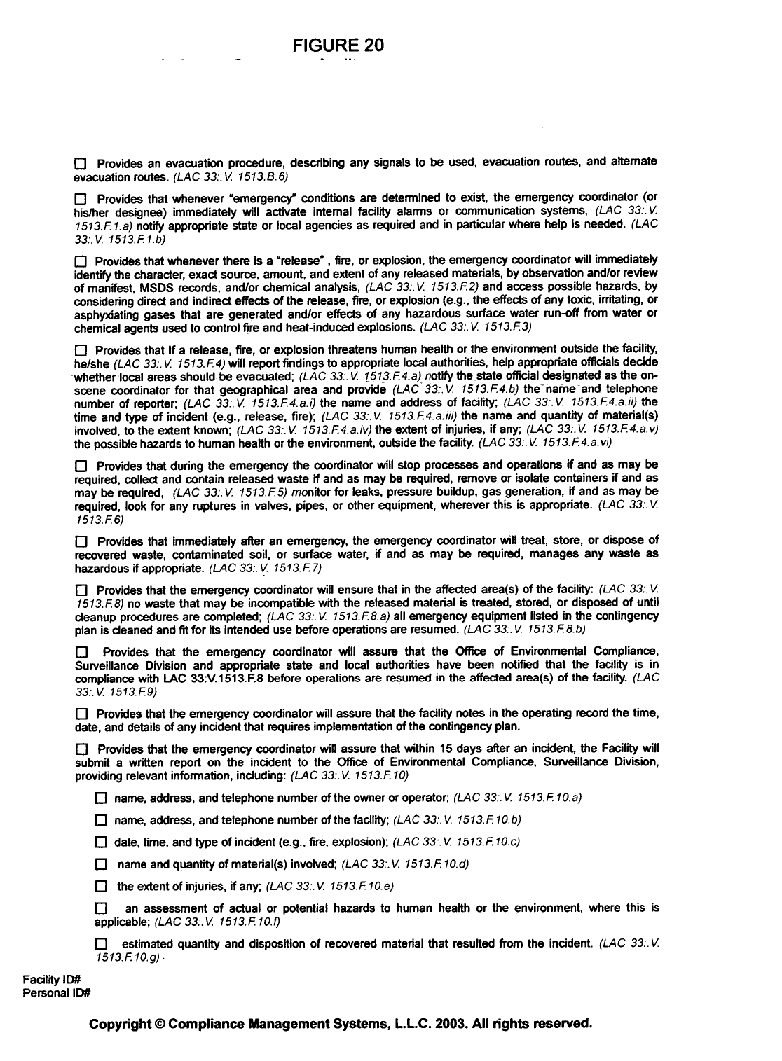

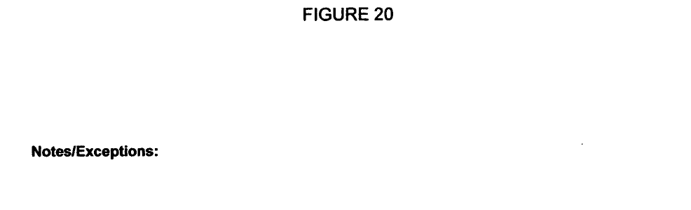

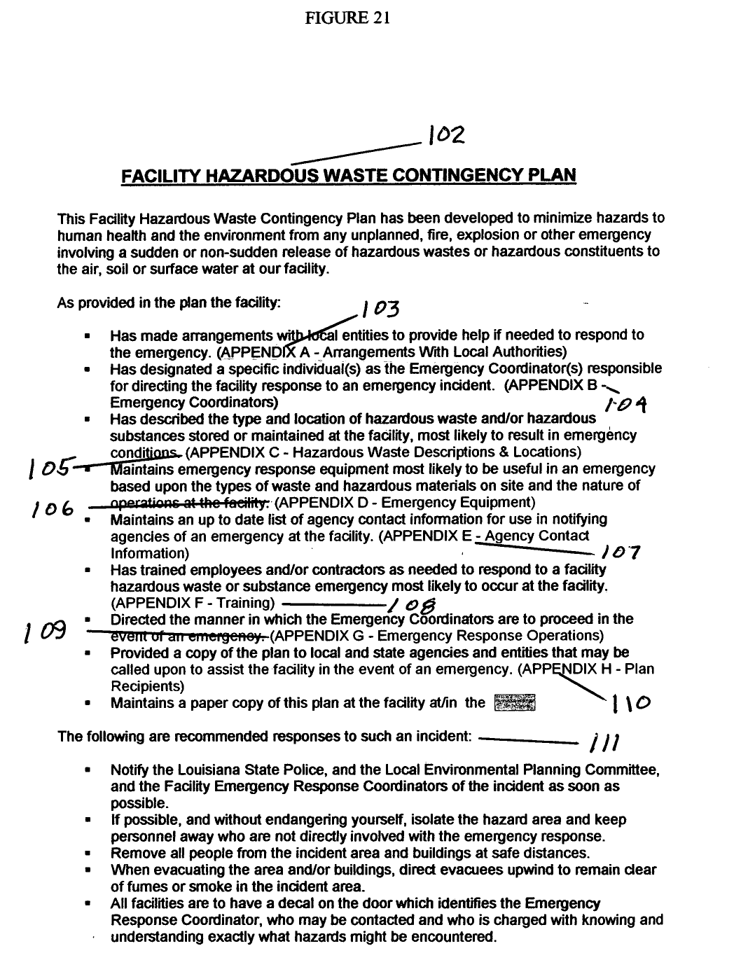

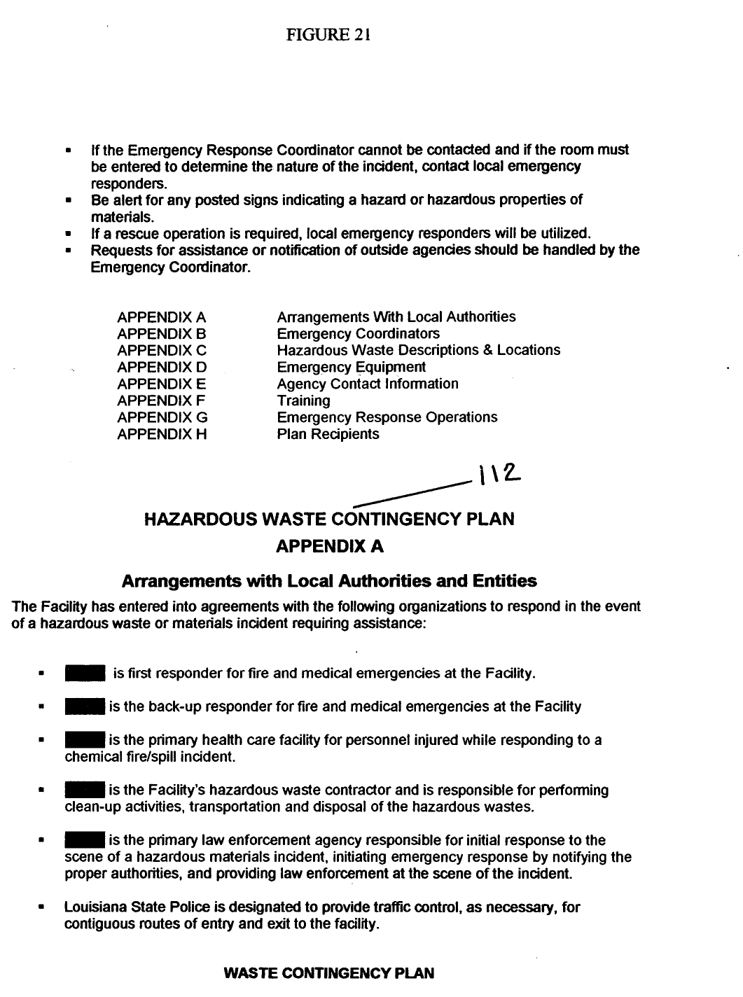

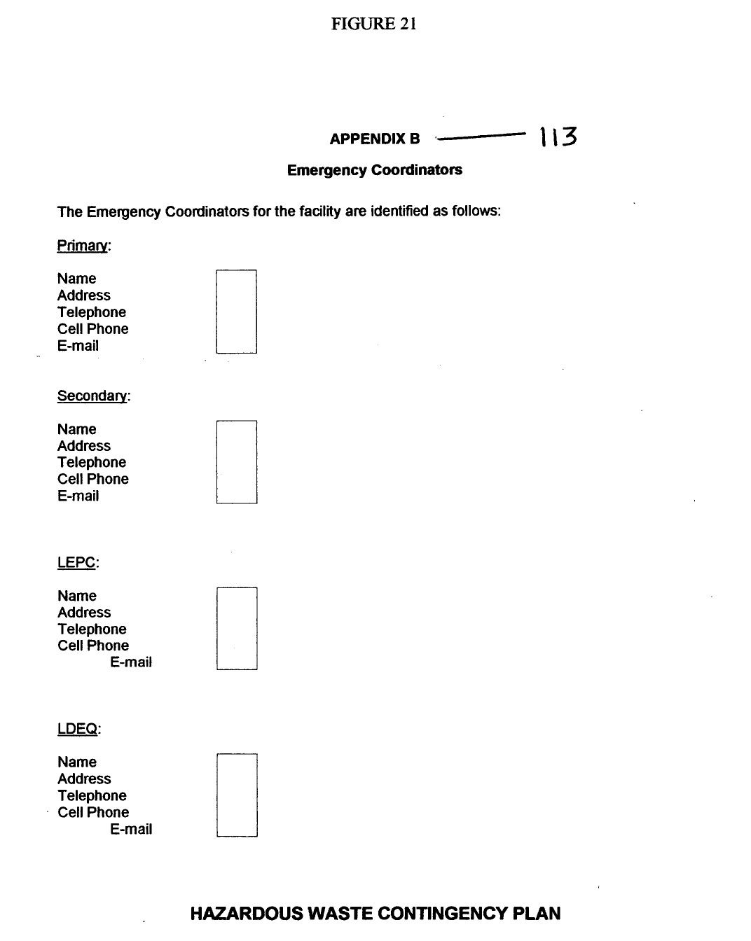

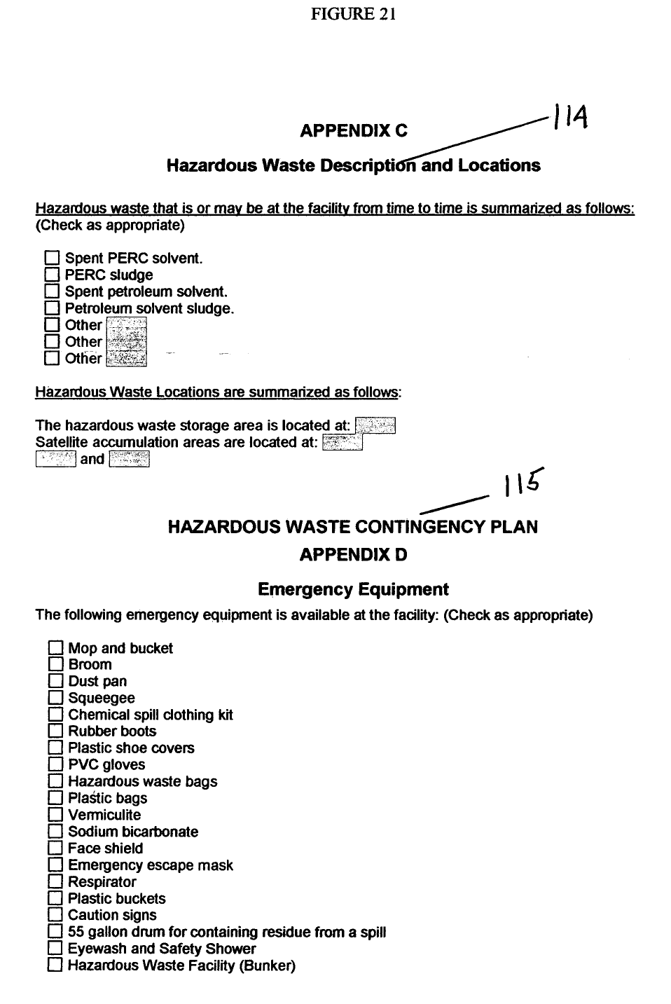

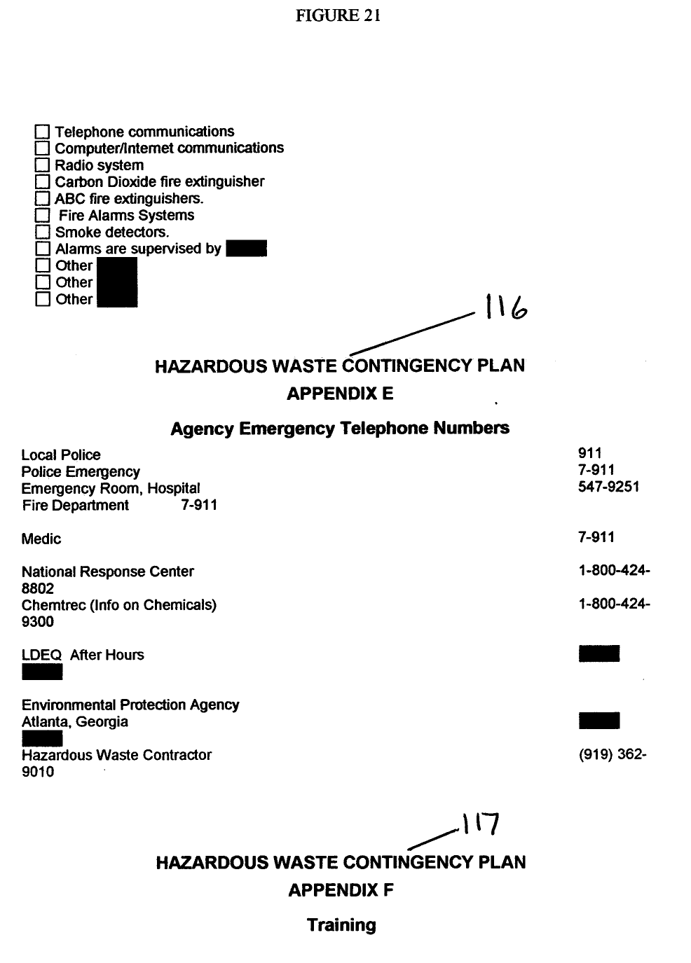

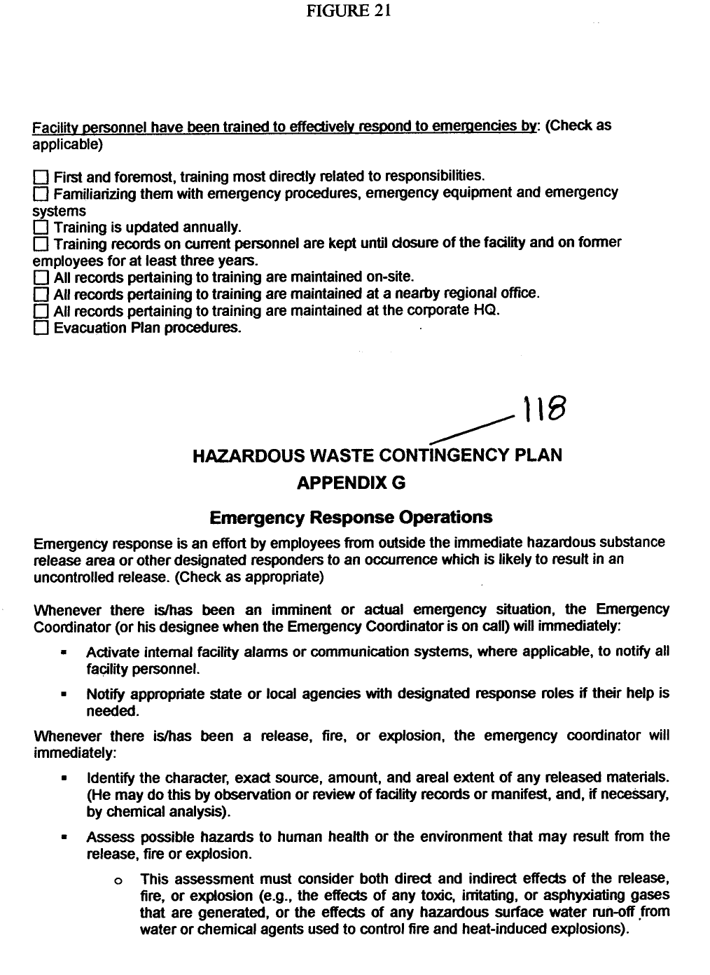

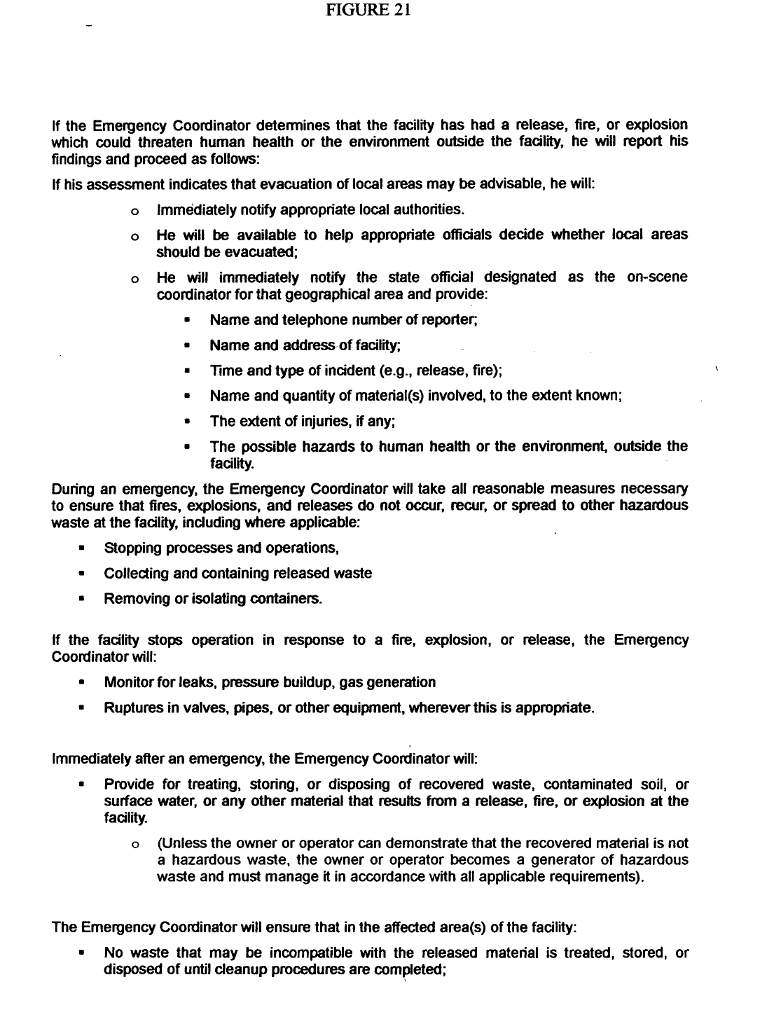

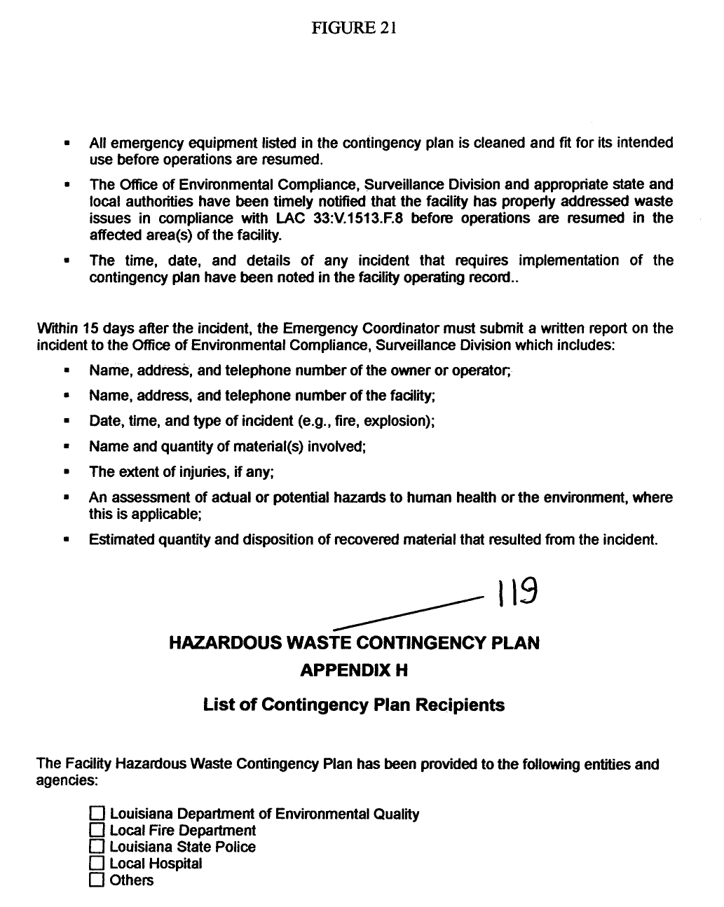

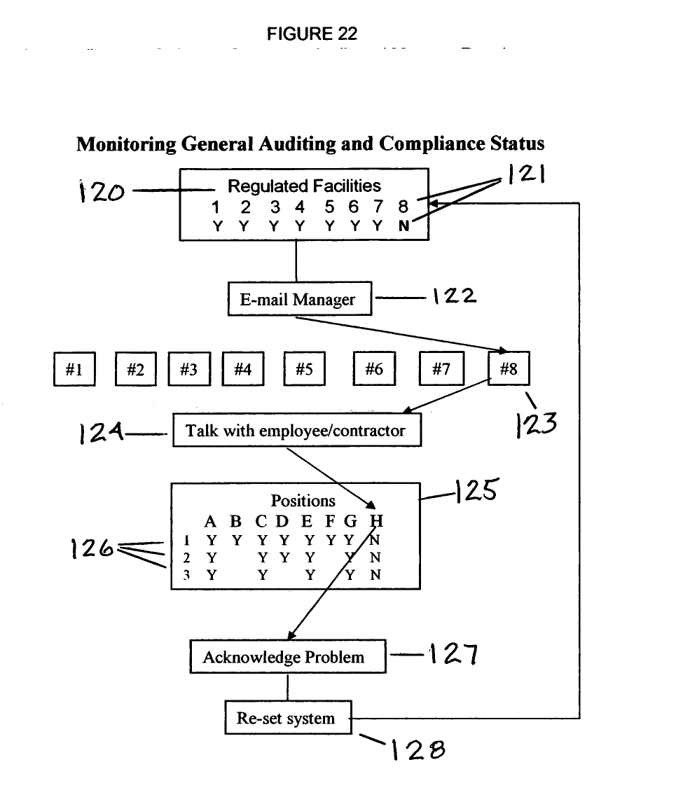

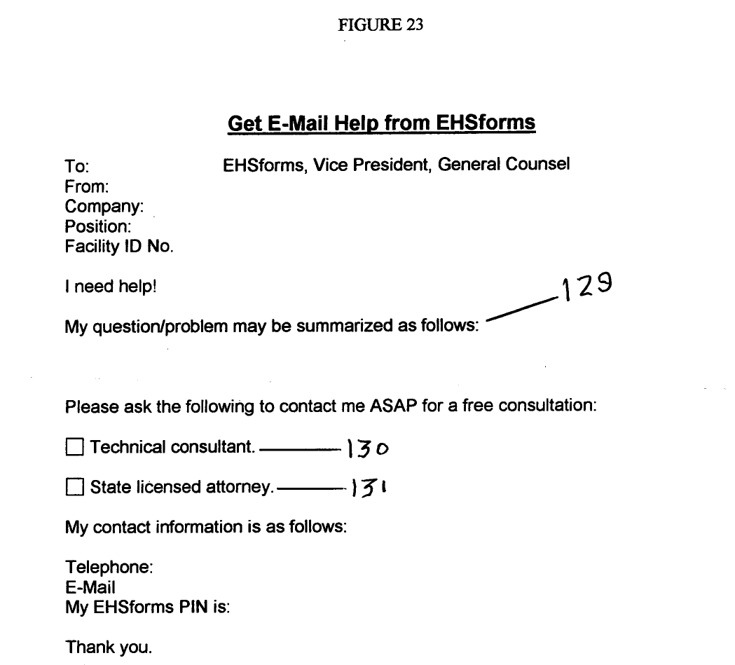

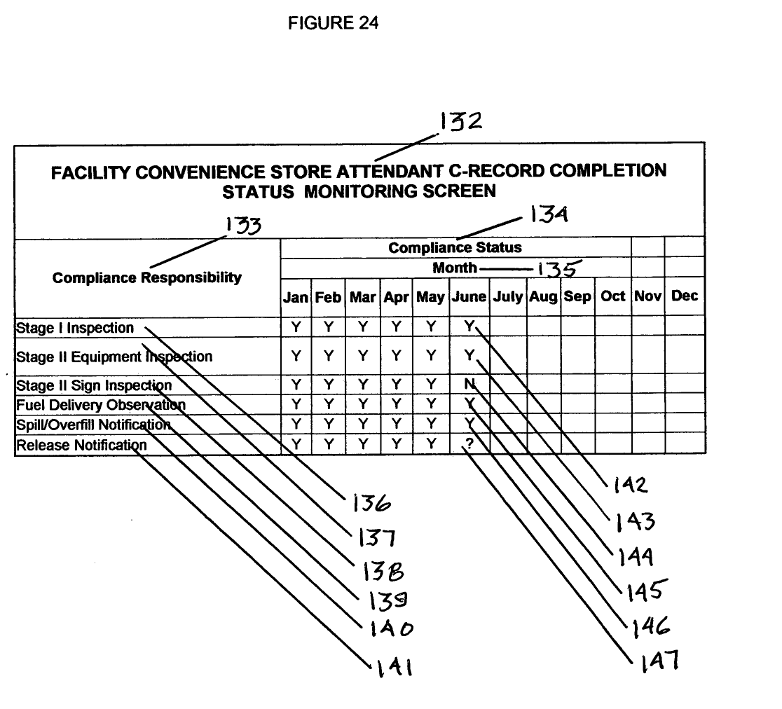

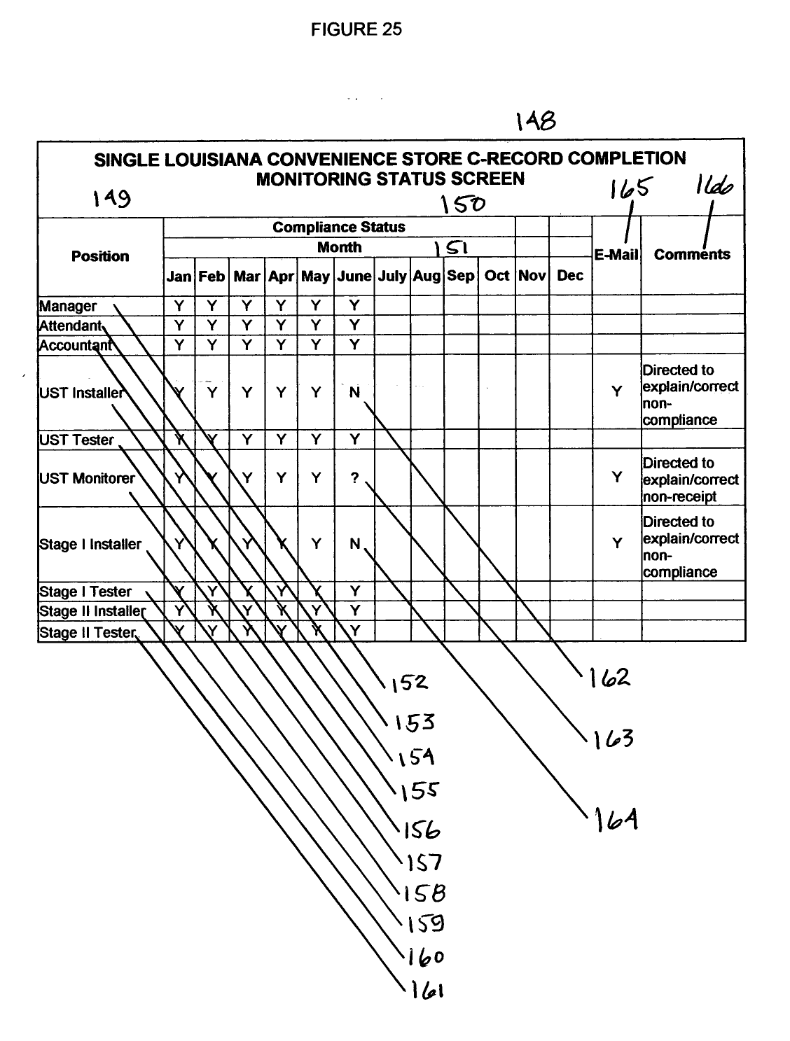

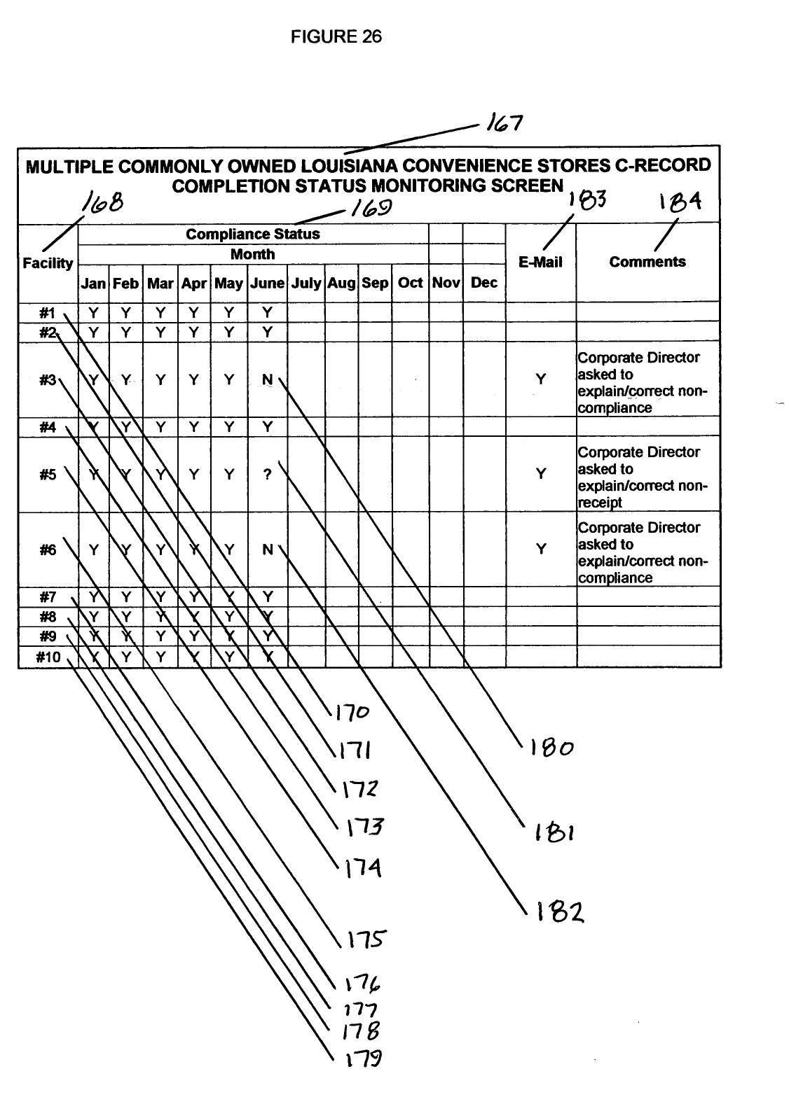

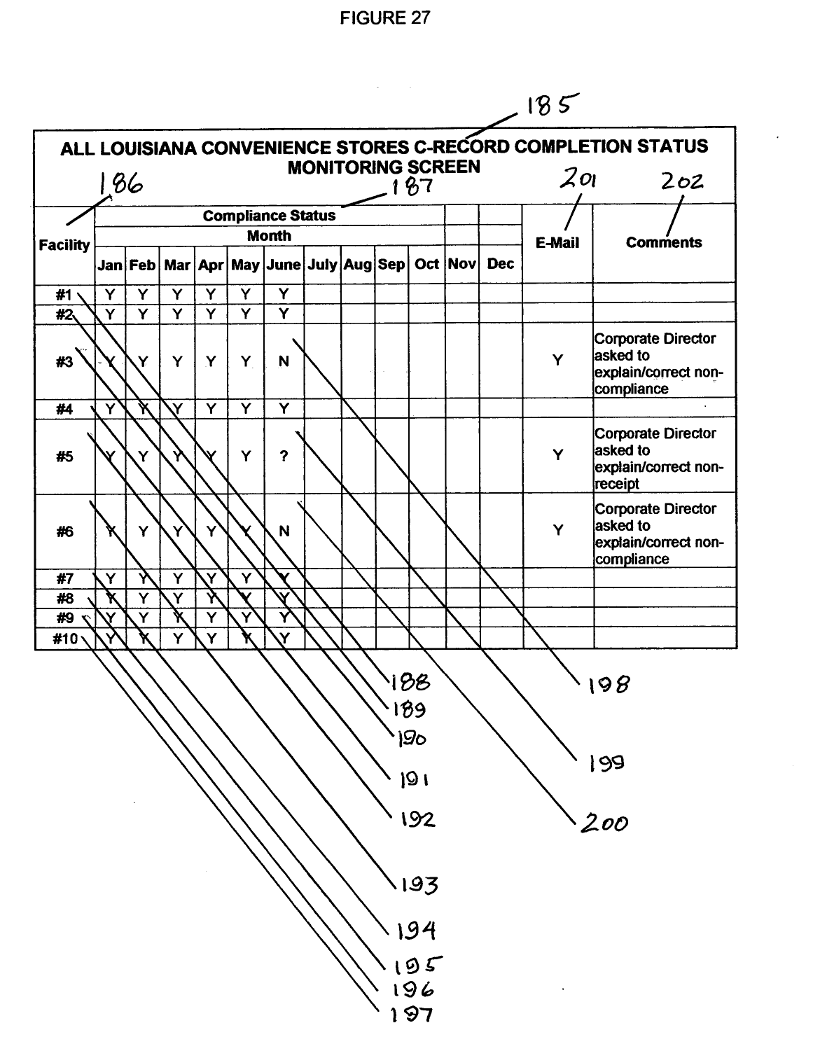

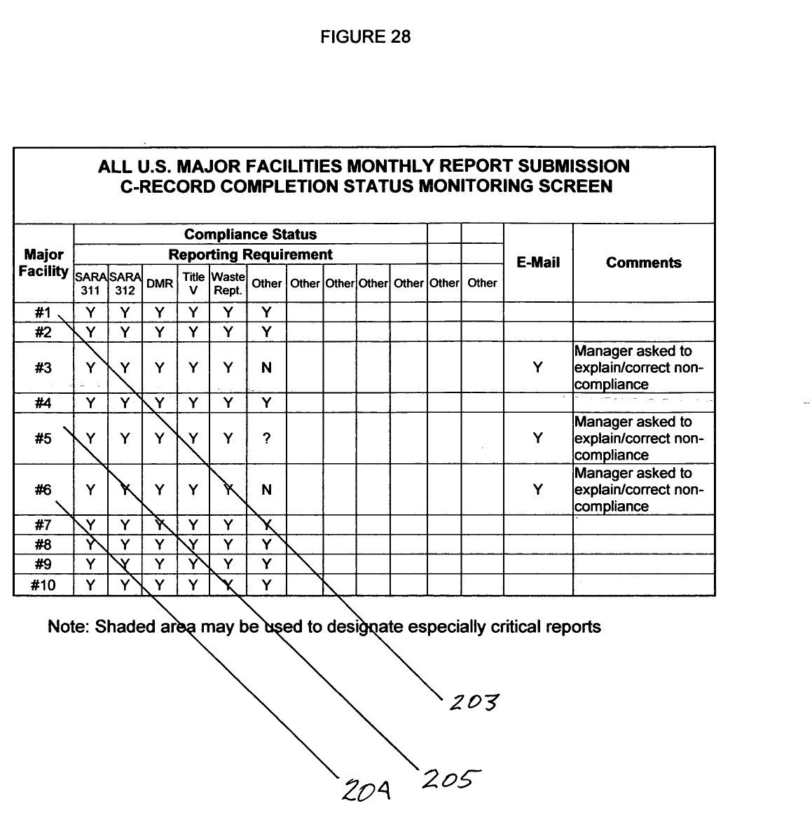

One reasonably well schooled in the art will recognize that each of the “Air”, (1) “Water”, (2) “Waste”, (3) “UST”, (4) “Other” (5), and “Notification” (6) groupings and sub-groupings depicted in FIG. 1 may be easily correlated with specific enumerated sections and subsections of the U.S. CFR, (7) and/or various state administrative codes, (8) addressing progressively more and more detailed groupings and sub-groupings of requirements potentially applicable to each minor facility.

Again, with reference to FIG. 1, one reasonably well schooled in the art will also recognize that similar, but not necessarily identical requirements may be imposed via federal regulations (9) as well as state regulations (10), since the various states are authorized under many federal statutes to promulgate regulations more stringent, (but not less stringent) than federal regulations in any particular area.

Once again, with reference to FIG. 1, one reasonably well schooled in the art will recognize that in order to comply with each of the various applicable requirements such, as for example, UST Design (11), UST Operation (12), UST Monitoring (13) and UST Reporting (14) requirements, a minor facility must be in compliance with a plurality of more detailed “applicable requirements” set forth in the applicable regulations.

Also by way of example and again with reference to FIG. 1, the title or heading of a specific a UST design regulation may impose a requirement on a minor facility to assure that all underground storage tanks are properly designed, whereas various different sections or subsections of the same regulation may apply and provide detailed design requirements that must be met depending on the particular type of tank installed. Hence, the user would be required to fully comply with all detailed requirements in order to confirm full compliance with the specific design requirement.

Once again, with reference to FIG. 1, one reasonably well schooled in the art will also recognize that the specific sections of both the CFR and various state codes containing detailed regulatory requirements applicable to minor facilities may be easily identified, and templates identifying groupings of regulations applicable to a plurality of different minor facilities may be developed, including, for example, templates applicable to each of the following minor facilities:

Automobile dealerships, as depicted in FIG. 2 identifying all groupings of state and federal environmental regulatory requirements applicable to automobile dealerships, shown within clear or non-shaded boxes (15) as well groupings of template requirements which are not applicable to automobile dealerships, shown within shaded boxes. (16)

Chiropractor, doctor and dentist offices, as depicted in FIG. 3 identifying all groupings of state and federal environmental regulatory requirements applicable to chiropractor, doctor and dentist offices.

Hospitals, as depicted in FIG. 4 identifying all groupings of state and federal environmental regulatory requirements applicable to hospitals.

Paint and body shops, as depicted in FIG. 5, identifying all groupings of state and federal environmental regulatory requirements applicable to paint and body shops.

Motor vehicle air conditioning shops, as depicted in FIG. 6 identifying all groupings of state and federal environmental regulatory requirements applicable to motor vehicle air conditioning shops.

Tire shops, as depicted in FIG. 7 identifying all groupings of state and federal environmental regulatory requirements applicable to tire shops.

Dry cleaners, as depicted in FIG. 8 identifying all groupings of state and federal environmental regulatory requirements applicable to applicable to dry cleaners.

Airport screeners, as depicted in FIG. 9 identifying all groupings of state and federal environmental regulatory requirements applicable to airport passenger and baggage screening operations.

Convenience stores or gas stations as depicted in FIG. 10 identifying all groupings of state and federal environmental regulatory requirements applicable to convenience stores and gas stations.

One well schooled in the art will also recognize that similar templates might easily be developed to address many other types or groupings of regulatory requirements promulgated by any and all other state and federal regulatory agencies, applicable to a plurality of other types of minor facilities.

3. Developing C-Records

It is a preferred embodiment of the present invention that at least one C-Record might be drafted for every minor facility applicable requirement and/or major facility reporting requirement to make sure the system anticipates every possible compliance election or option available to a facility.

For example, by reference to FIG. 10, a minor facility may elect to comply with UST monitoring requirements (21) in any of several different ways, including, for example by reference to FIG. 13 liquid monitoring, vapor monitoring, interstitial monitoring, statistical inventory reconciliation, and manual tank gauging (53). Hence, in the example, a separate C-Record must be developed for each of the foregoing available compliance options.

It is also a preferred embodiment of the present invention to convert the text of applicable requirements into checklist format (20) in order to simplify and facilitate C-Record completion by users. Anyone reasonably well schooled in the art will recognize that various entire sections of applicable requirements may be electronically copied from the CFR and/or state codes and electronically pasted into an electronic document using readily available commercial software such as Microsoft Word for example.

In one application of the invention, as shown in FIG. 11, the overarching or primary requirement (22) addressed by a regulatory section, chapter or title may be determined and prominently displayed at the top of the C-Record, with more detailed “applicable requirements” (23) set forth below.

In addition, it is a preferred embodiment of the present invention to use electronic checkmarks to facilitate completion as well as hyperlinks to direct the user to various other electronic documents helpful in better explaining applicable requirements or reporting requirements addressed by each C-Record.,

For example, “Learn More”, (24) “See Text”, (25) and “Take Test” (26) links, may be easily developed and incorporated into each formatted C-Record (27), as shown in FIG. 11.

It is also a preferred embodiment of the present invention to configure all C-Records as nearly as reasonably possible in an identical manner so as to minimize chances of confusion by a user, when efficiently accessing and completing a plurality of C-Records within a short period of time.

B. Accessing the Invention

It is a preferred embodiment of the present invention that it be easy to access by a plurality of users at various geographically dispersed facilities, via the WWW.

An example of the manner in which a potential user might easily access the invention via a service provider is shown in FIG. 12. (31) The service provider may publish one or more WWW web pages describing compliance management services in detail and sufficient to allow a potential user to determine applicability at his/her facilitiy(ies). The provider might also identify individuals employed by the service provider, how the invention works, and what guarantees or warranties are to be given to users.

C. Completing a Facility Profile

Before use of the invention by responsible facility employees and/or contractors, the manager of each facility, might, according to the preferred use of the invention, be directed to sign on to the providers website to complete a facility profile (FIG. 13, note 43) providing information about facility operations needed to identify specific C-Records applicable to the facility. By way of example, in order to most efficiently obtain needed information, the profile might prompt a minor or major facility user to check boxes identifying various regulated activities undertaken at the facility (30) and download appropriate facility C-Records based upon boxes checked. (See FIG. 11, notes 27, 28, 29 and 30)

By way of yet another example, and again with reference to FIG. 13, one question applicable to a convenience store might be—does the facility operate UST's? (45). If the answer is “yes”, the manager might then directed to check additional boxes (46) providing more detailed information, in response to additional questions such as: What kind of tanks? (48) What kind of piping systems? (50) What kind of tank release detection monitoring has been installed? (52) and: What kind of pipe release detection monitoring has been installed? (54)

Anyone reasonably well schooled in the art will recognize that the system might easily be configured to identify one or more applicable C-Records based upon the boxes checked by a manager, and eliminate other C-Records based upon boxes that are not checked.

Applicable C-Records might then be identified and downloaded (47), such as for example: applicable UST tank design and operating C-Records (49), applicable piping system design and operating C-Records, (51), applicable tank release detection system C-Records (53) and applicable piping release detection system C-Records. (55).

Similarly, anyone reasonably well schooled in the art will understand that the invention might easily be configured to provide similar facility profiles matching needs of a plurality of different types of facilities, regulated by a plurality of different regulatory agencies.

D. Assigning C-Record Completion Responsibilities

Once a facility profile has been completed, and with reference to FIG. 11, a facility manager, or other authorized representative might be prompted to: identify all facility employee and/or contractor positions to be held responsible for completing all C-Records applicable to the facility; assign completion responsibilities (28); download and store applicable C-Records in a facility database, (29) and/or; audit/compliance files created for each position with compliance responsibilities. (30)

Alternatively, the system might be configured to assign compliance responsibilities by “default” to various positions deemed most likely to be held responsible at most facilities of the same type and require the manager to either accept or reject default C-Record completion assignments.

E. Access and Use of C-Records

The specific manner in which C-Records may be accessed by a user would be highly variable and dependent on the particular application of the invention anticipated by the user.

In one application of the invention, and by reference to FIG. 14, after all C-Records have been identified and assigned to responsible positions, the system might easily be configured to automatically direct responsible employees and contractors (by e-mail or otherwise) to sign on to the providers web page under his/her position (56) and either audit for past compliance (57) or periodically confirm on-going compliance with applicable requirements, at various time intervals thereafter. (58)

Again with reference to FIG. 14, a preferred embodiment of the present invention might require the user to confirm compliance with applicable requirements based on the existence of written or electronic records on file at the facility or elsewhere, with a rebuttable presumption of non-compliance being established in the absence of his/her ability to produce records.

Also, and again depending upon the specific facility and application anticipated, the system might be configured to allow the user to access an intermediate document or “clipboard” assigned to his/her position at a facility containing links to audit C-Records (59) and/or compliance C-Records. (60)

In order to perform an audit, and, again with reference to FIG. 14, a responsible employee or contractor might be directed to sign in under his or her position, and sequentially access and complete all Audit C-Records transferred into his/her electronic mailbox. By way of example, 3 C-Records are shown in both the audit file (61) as C-Records #1, #2 and #3 (63) as C-Records #1, #2 and #3 (64).

The user might also be directed to complete C-Records, with reference to FIG. 12, (42) as needed to confirm full compliance with applicable requirements, as shown by reference to FIG. 15 at note 81 or 82.

Completed C-Records might be maintained in a C-Record database (67) as shown in FIG. 14, either on a server maintained by the service provider or on computers at each facility. (65)

In yet another application of the present invention, and as depicted in FIG. 14, the system might also be easily configured to automatically delete compliance records not required to be maintained as a matter of law, after management has had ample opportunity to identify possible non-compliance and implement corrective action. (69)

F. Knowledge Verification

It is a preferred embodiment of the present invention, that C-Records may be used and completed with equal ease and understanding by experienced or inexperienced employees and/or contractors, as well as substitutes for vacationing employees and/or contractors without requiring any such employees and/or contractors to read the detailed regulations upon which applicable requirements are based.

It is also a preferred embodiment of the present invention that the user might be directed to verify that he/she understands applicable requirements sufficient to properly complete C-Records assigned to his/her position before being permitted to complete the C-Record.

It is also a preferred embodiment of the present invention that this be accomplished by providing the user easy access to: useful background information concerning the applicable requirements; the actual text of the regulatory requirements, and; a method of verifying the users specific knowledge of the applicable requirements. For example, and with reference to FIG. 15, before being permitted to confirm compliance with perchloroethylene record keeping requirements, the user might be directed to: Click on the “Learn More” link (76) to read information about perchloroethylene, shown in FIG. 16 at (89; Click on the “See Text” link, (77) to read the actual text of the regulation upon which the C-Record is based, as presented in FIG. 17 at (90), and; Click on the “Take Test” link (78) to access and take the test depicted in FIG. 18 at (91).

Again, with reference to FIG. 18, it is a preferred embodiment of the present invention that the test document be configured so as to solicit all relevant information from the user including: name, (92) position, (93) and personal identification number or PIN (94) as well as to provide a listing of statements (96) which may be read by the user and designated as being true (97) or false (98).

If after reading all relevant information and taking a test the user still cannot fully understand applicable requirements, as depicted in FIG. 15, he/she might be directed to click on a “Get Help” (79) to send an e-mail to the service provider requesting free legal and/or technical help, as depicted in FIG. 23.

The Internet provider might elect to form business relationships with various attorneys and consultants in each state for the purposes of better assisting those requiring and requesting help.

G. Facilitating On-Going Compliance

According to one application of the instant invention, once a user is satisfied that he/she fully understands applicable requirements (and passes a test, if required by management), he/she might be directed to audit past compliance and/or confirm on-going compliance with applicable requirements set forth in the C-Record.

By reference to FIG. 15, it is a preferred embodiment of the present invention, that the system might be easily configured to allow the user to confirm full compliance with overarching or primary requirement addressed by each C-Record (80) by checking on the appropriate box to show that the facility has “good records” . . . (81) and in addition, by checking appropriate boxes to show full compliance with all more detailed “Applicable Requirements” (85) in order to assure full compliance with the primary requirement. (80)

Alternately, and also with reference to FIG. 15, if good records cannot be produced by the user, he/she might be directed to check the box next to “We need better records . . . ” (82) to not only alert alert the manager of possible non-compliance, but also to gain access to various forms, checklists preformatted letters and various other compliance assistance documents designed to help the user attain and maintain full compliance. (83)

For example, and again by reference to FIG. 15, if and when records cannot be produced to confirm full compliance, the user might be directed to check the box next to “We need better records.” . . . (82) and also click on the “Monthly Perchloroethylene Purchase Records” link (83) to access a form that can be used to record full compliance with applicable requirements in the future, as depicted for example in FIG. 19. Moreover, such compliance assistance documents may include instructions for use (100) and may easily be developed to facilitate generation of compliance records at the facility, by automatically comparing past and present year purchases as necessary to automatically calculate running totals of perchloroethylene purchases as required by the certain applicable requirements for example. (99)

It is a preferred embodiment of the instant invention that compliance assistance documents need not be limited to forms used to track usage, but may include a virtually unlimited plurality of different requirements, such as for example, requirements to develop and maintain various plans, such as with reference to FIG. 20, hazardous waste contingency plans strictly following specific regulatory requirements. With reference to FIG. 20, the invention may be easily configured to assist in this manner by presenting a user with a link (101) to a hazardous waste plan template as depicted in FIG. 21 which may easily be tailored to suit conditions at a facility. More specifically, the template may be configured to include links to all sections required by law.

For example, clicking on: “Arrangements With Local Authorities” (103), would access information shown at (112); clicking on “Emergency Coordinators” (104) would access information shown at (113); clicking on “Hazardous Waste Descriptions and Locations” (105) would access information shown at (114); clicking on Emergency Equipment (106) would access information shown at (115); clicking on “Agency Contact Information” (107) would access information shown at (116); clicking on “Training” (108) would access information shown at (117); clicking on “Emergency Response Operations” (109) would access information shown at (118) and; clicking on “Plan Recipients” (110) would access information shown at 119.

Hence, it is another preferred embodiment of the present invention that the invention may be used not just to alert a user of possible non-compliance but to give the user documents needed to come into full compliance as well, by allowing the user to tailor preformatted compliance assistance documents and plans to his/her facility by checking appropriate boxes to indicate information applying to each facility and/or by filling in blanks to indicate information applying to each facility.

Anyone reasonably well schooled in the art will recognize that similar compliance assistance templates may be easily established to meet a plurality of other requirements, including for example hazardous waste preparedness plans and hazardous waste training plans.

H. Scheduling Auditing and Compliance

It is a preferred embodiment of the present invention that during the normal course of the use of the invention at most minor facilities, employees and contractors with regulatory compliance responsibilities might be required to sign on to the providers web page and audit to confirm past facility compliance with applicable requirements, before being periodically prompted to confirm on-going compliance with applicable requirements and/or reporting requirements, at various time intervals thereafter.

1. Auditing Past Compliance

It is a preferred embodiment of the present invention that responsible employees and contractors at each facility might be directed to audit and confirm past compliance with all applicable requirements soon after a facility manager or other authorized representative completes and submits a facility profile. Based upon audit results, a user with compliance responsibilities might discover that he/she cannot produce records needed to confirm past compliance with applicable requirements, and/or reporting requirements, and be directed to use various compliance assistance documents offered to generate needed compliance records in the future.

Also, based upon the audit results, the facility manager might be directed to notify various users of non-compliance, if applicable, and require use of appropriate compliance assistance documents to minimize chances of future non-compliance.

2. Compliance Assistance

It is a preferred embodiment of the present invention that the system be configured to assist responsible positions in complying with all scheduled as well as unscheduled applicable requirements and/or reporting requirements.

a. Scheduled Requirements

In some cases, employees and/or contractors may be required to comply with scheduled applicable requirements every day, every week, bi-weekly, monthly, every calendar quarter, or every year, or otherwise as may be appropriate under the particular circumstances.

By way of example, a requirement to test a UST leak detection system annually or inspect vapor controls at a convenience store annually would be an example of a scheduled event. Anyone reasonably well schooled in the art would know that compliance might easily be scheduled, and responsible employees/contractors prompted to access and complete required C-Records when it is time to comply, in a variety of ways.

One way this might be accomplished would be to configure the system so that a schedule of all compliance tasks is created for each position at the time of completion of the facility profile, and modified accordingly if and when the profile might be changed by a facility manager.

Unlike past art, the present invention might be configured to significantly minimize the possibility of non-compliance by scheduling completion of events during or soon after completion of each facility profile and by notifying all responsible users if and when necessary to comply and/or confirm compliance with scheduled state and federal requirements.

It is a preferred embodiment of the present invention that the system may also be configured to notify or alert users before its time to comply with scheduled requirements.

For example, the system might be configured to warn or alert responsible employees and/or contractors within a specified period of time before compliance is required as well as notify management if and when compliance is not timely recorded.

b. Unscheduled Requirements

Examples of unscheduled events may include the installation of a new UST at a convenience store, delivery of fuel to a convenience store, and/or closure of a UST or fuel spill at a convenience store. Likewise, an observation of a passenger meeting a certain profile in an airport check-in line might be an unscheduled event, requiring confirmation of compliance.

It is also a preferred embodiment of the present invention that the system might be configured to direct responsible employees and contractors to complete one or more C-Records after the occurrence of an unscheduled event. By way of example, a facility attendant might be directed to inspect certain control equipment everyday (and complete appropriate C-Records) as required by applicable requirements, and also to notify authorities and complete an appropriate C-Record if and when an unexpected fuel spill should occur.

In addition, unlike past art, the present invention might be easily configured to greatly minimize or eliminate the possibility of non-compliance with unscheduled events by directing responsible employees and contractors to complete C-Records upon the happening of any such unscheduled event, such as the delivery and transfer of fuel to s UST, for example.

Also, unlike past art, the present invention might be easily configured to address any and all new applicable requirements resulting from changes in a facility, that occur after completion of a facility profile, by directing a facility manager to modify the facility profile before he/she allows such a change to occur. (ie add a UST or close a UST) and to do so at some time interval before a change with regulatory consequences is implemented. (44)

In accordance with the teachings of the present invention, and with reference to FIG. 13, the system might easily be configured to automatically launch an e-mail notification to all employees or contractors affected by the proposed change, alerting all such employees/contractors of the need to complete additional C-Records.

3. Confirming On-Going Compliance

Periodic ongoing audits for continuing compliance may be performed according to any schedule determined by facility, or corporate management (or a regulatory agency if applicable) under the circumstances presented.

The particular period between periodic audits might best be adjusted according to, among other things the seriousness of potential on-going violations and the regulatory reporting frequency (if any) required.

By way of example, facility compliance with hazardous waste contingency plan requirements (See FIG. 20 at 101) might be required to be confirmed annually, since need for changes between audits would be relatively unlikely, whereas, the requirement to maintain monthly perchloroethylene purchase records (See FIG. 15 at 80) might be confirmed monthly.

H. Monitoring Compliance Status

With reference to FIG. 22, it is a preferred embodiment of the present invention that the system may be configured to allow authorized individuals, including but not necessarily limited to employees, contractors, managers, directors, officers, lawyers, bankers, consultants, regulatory agency representatives and insurers, to access the system and monitor compliance status for any facility, via the WWW, at any time.

In one example of the application of the present invention, and by reference to FIG. 22, an authorized user might easily learn that one (121) of eight facilities (120) cannot produce records confirming compliance with applicable requirements or reporting requirements, set forth in a C-Record, or has simply failed to submit a completed C-Record at all, in which case non-compliance may be assumed.

In another example, again with reference to FIG. 22, after observing that facility #8 was not in compliance (121) a corporate or district manager of the facility, for example, might elect to send the manager of the non-compliant facility an e-mail (122) inquiring as to the reason for the apparent non-compliance at the offending facility. (123).

Alternatively, and once again with reference to FIG. 22, the manager of a facility might himself/herself observe an apparent non-compliance by a employee or contractor (124) and directly query the responsible individual about the problem (125) and, also by way of example, direct the responsible individual to implement corrective action.

It is also a preferred embodiment of the present invention that the system might be easily configured to not only identify specific C-Records not submitted or indicating non-compliance (126) but also to identify all sections or subsections of the regulations, or specific detailed applicable requirements, with which the user has failed to confirm compliance.

Also and once again with reference to FIG. 22, the system might easily be configured to allow the responsible employee/contractor himself/herself to acknowledge non-compliance and/or confirm implantation of corrective action (127).

It is also a preferred embodiment of the present invention that, as shown in FIG. 22, it might easily be configured to delete all records of noncompliance, (not required to be kept as a matter of law), and reset the system (128), after notice of non-compliance has been provided to management.

1. Employee and Contractor Compliance Status

It is a preferred embodiment of the present invention, as shown in FIG. 24, that the system might easily be configured to allow any employee or contractor with C-Record completion responsibilities to easily confirm his/her C-Record completion status at any time via the WWW. (132)

Again, with reference to FIG. 24, one reasonably well schooled in the art will recognize that the system might easily be configured to allow a facility attendant serving at a convenience store, for example, to view his/her C-Record completion compliance status (134); to understand his/her C-Record compliance/completion responsibilities, or C-Records requiring completion (133); understand that he/she is expected to complete 3 scheduled C-Records every day, namely Stage I Equipment Inspection (136) Stage 1I Equipment Inspection (137) and Stage 1I Sign Inspection (138) as well as 3 additional unscheduled C-Records, upon the happening or non-happening of certain events, namely if and when fuel is delivered to UST's (139); if and when there has been a fuel spill or overfill (140) and/or; if and when a hazardous substance has been released to the environment (141).

By further example of the manner of function of the invention, and again with reference to FIG. 24, the system could easily be configured to show the C-Record compliance status for the attendant, such as for example where the attendant had in fact timely confirmed full compliance with: Stage I Inspection C-Record completion responsibilities, (142) and Stage 1I Equipment Inspection C-Record completion responsibilities (143) and Fuel Delivery Observation C-Record completion responsibilities (145) and Spill/Overfill Notification C-Record completion responsibilities (146) but failed to confirm/timely submit Stage 1I Sign Inspection C-Record completion responsibilities (143) and/or Release Notification C-Record Completion responsibilities (147).

In addition, and once again with reference to FIG. 24, anyone reasonably well schooled in the art will recognize that the system might easily be configured to electronically alert the facility attendant, or any other responsible employee or contractor if changed circumstances should necessitate completion of any additional forms, by e-mail and/or by simply adding the C-Record applicable to the new requirements under “Compliance Responsibilities” (133) assigned to the position.

2. Single Facility Compliance Status

It is a preferred embodiment of the present invention that the system might easily be configured to allow the manager of each facility to easily confirm the C-Record compliance status of all positions serving at his/her facility, via the Www.

For example and with reference to FIG. 25, one reasonably well schooled in the art will recognize that the system might easily be configured to allow the manager of a minor or major facility to access a screen showing the C-Record completion status for all positions with environmental responsibilities serving his/her facility.

For example and again with reference to FIG. 25, the system might be configured to allow the manager to determine that for the month of June, all positions timely submitted C-Records confirming full compliance, with the exception of the UST Installer (155) (162) and the Stage I Installation Contractor, (158) (164) and (possibly) the UST Monitorer (157) who failed to submit a completed C-Record. (163)

Furthermore it may be seen from the above example that, the system might easily be configured to allow a facility manager to automatically, (or manually) notify non-compliant positions about non-compliance (165) and record applicable comments about such non-compliance. (166)

3. Multiple Facilities Compliance Status

It is a preferred embodiment of the present invention that the system might easily be configured to allow various authorized individuals to monitor initial audit results and/or on-going compliance at one or a thousand facilities, anytime, via the WWW.

a. Minor Facilities

It is a preferred embodiment of the present invention that the system might easily beconfigured to allow a regional or national director/manager of a business entity owning/operating minor facilities to easily confirm the audit and/or ongoing (C-Record completion) compliance status of all facilities operating in any single state or in all states, for which he/she has overall compliance responsibilities, via the WWW.

For example and with reference to FIG. 26, one reasonably well schooled in the art will recognize that the system might easily be configured to allow the manager of one or more facilities to access a screen showing the C-Record completion status for all positions with environmental responsibilities serving his/her facility.

For example and again with reference to FIG. 26, the system might easily be configured to allow a facility director/manager to determine that for the month of June, for example, all Louisiana facilities (#1-#10) had timely submitted C-Records confirming full compliance with applicable requirements, except for facility #3, (172) facility #5, (174) and facility #6 (175), as shown in FIG. 26 at (180), (181) and (182).

Furthermore it may be seen from the above example that, the system might easily be configured to automatically, (or alternatively to allow a facility manager to manually) notify non-compliant positions about non-compliance (183) and record comments about such non-compliance. (184)

b. Major Facilities

It is a preferred embodiment of the present invention that the system may be easily configured to allow a regional or national director/manager of major facilities to easily confirm the C-Record compliance status of all major facilities operating in any single state or in all states, for which he/she has entity responsibilities, via the WWW.

Such may be accomplished by simply listing all applicable reporting requirements and directing responsible parties to periodically indicate compliance status with respect to each requirement.

For example, and with reference to FIG. 28, the manager or director of regulatory affairs for an entity with multiple major facilities across the United States might easily view the report submittal compliance status of all major facilities, including facilities that have confirmed such as Major facility #1 (203) as well as those that have not timely submitted confirmation (204) and those that have confirmed non-compliance (205).

4. Determination of Compliance Status by Regulatory Agency

It is a preferred embodiment of the present invention that the system might easily be configured to allow a state or federal regulatory agency to easily confirm the C-Record compliance status (and thereby compliance with applicable regulatory requirements) for all facilities operating in any single state or in all states, for which an agency has enforcement jurisdiction, via the WWW.

With reference to FIG. 27, one reasonably well schooled in the art will recognize that the system might easily be configured to allow an inspector or enforcement officer with a regulatory agency to access a screen displaying the C-Record completion status for all facilities of the same minor facility type within its jurisdiction.

For example and again with reference to FIG. 27, the system might be configured to allow an authorized agency representative to determine that for the month of June, all Louisiana facilities had timely submitted C-Records confirming full compliance with applicable requirements, with the exception of facility #3, (190) facility #5, (192) and facility #6 (193).

Furthermore it may be seen from the above example that, and again with reference to FIG. 27, that the system might be configured to allow an authorized agency representative to determine that for the month of June, facility #5 had failed to submit one or more a completed C-Records (199) while both facility #3, (198) and facility #6 (200) had submitted completed C-Records which did not confirm full compliance.

Furthermore it may be seen from the above example that, the system might easily be configured to automatically, (or alternatively to allow an authorized agency representative to manually) notify non-compliant facilities about non-compliance (201) and record applicable comments about non-compliance. (202)

The invention might easily be configured to allow an authorized regulatory user to monitor on-going compliance with reporting requirements at multiple major facilities, nationwide.

For example and with reference to FIG. 28, the system might be configured to allow an authorized regulatory agency representative to determine that for the month of June, that all major facilities throughout the U.S. had timely confirmed submission of applicable reports to a regulatory agency, with the exception of facility #3, facility #5, and facility #6.

### IV. EQUIPMENT NEEDED TO USE THE INVENTION

The present invention requires the use of one or more processing units or CPU with main memory, input means, such as a keyboard and a mouse connected to the CPU/main memory; and two output devices, a display (such as a CRT, monitor, or other screen device) and a printer, also connected to the CPU/main memory. Storage device (e.g. a disk drive or a hard drive) communicates with the CPU/main memory and is the memory unit for storing application software, a “Facility profiler” database, a C-Records database, and a “Waste” database. The system also includes appropriate operating system software.

The preferred implementation platform of the present invention is a system implemented on an IBM compatible personal computer having at least four megabytes of main memory (RAM) and an eighty megabyte hard disk drive, with Microsoft Windows as the employee or contractor interface and Microsoft Excel and Microsoft Outlook as the database management software. Individual personal computers can be networked to give multiple employees or contractors access to common databases. A Dynamic Data Exchange (“DDE”) link may be used to communicate data between applications. However, other operating systems could be used. The system may be also be designed to support a wide range of web browsers. Other web browser enhancements may also be incorporated into the system for extra features.

For security purposes, access to documents may be limited or based on prior authorization. Codes or “tags” may be inserted into the document to identify attributes and for formatting purposes.

### V. ESSENTIAL ELEMENTS OF THE INVENTION

The essential elements of the invention include:

Software systems and method of identifying all requirements, including regulatory requirements applicable to a type of minor facility via the WWW;

WWW access to U.S. government and various state government websites, and/or various commercial websites, providing electronic text of regulations applicable to minor facilities.

A plurality of C-Records incorporating applicable requirements into electronic documents, capable of being used to confirm initial and on-going compliance with applicable requirements;

A “facility profile” to be completed by a manager of the minor facility to describe facility operations, sufficient to determine which of the applicable requirements (and C-Records) apply to the facility;

Software systems configured to allow each manager or other authorized representative of the minor facility to assign C-Record completion responsibilities to specific employees or contractors;

A WWW Internet site that may be accessed by minor facility managers, regulatory agency representatives and employees or contractors;

A security system to limit accessibility for different classes of employees or contractors;

Software systems configured to assist employees or contractors in auditing and/or complying and/or confirming continuing compliance with applicable requirements, and to store and manipulate the results of self-audits;

Software systems configured to allow authorized managers, regulatory agency representatives, and others, such as bankers, lawyers and consultants to monitor on-going compliance status of individual employees or contractors, at single facilities, or at all facilities via the WWW.

### VI. BRIEF DESCRIPTION OF THE DRAWINGS AND FIGURES

All figures represent a preferred embodiment, but other alternate embodiments are within the scope of the present invention.

FIG. 1 Master Environmental Regulation Template.

FIG. 2 Environmental Regulation Template Automobile Dealership—Louisiana.

FIG. 3 Environmental Regulation Template Chiropractor, Doctor, Dentist—Louisiana.

FIG. 4 Environmental Regulation Template Hospital—Louisiana.

FIG. 5 Environmental Regulation Template Paint and Body Shop—Louisiana.

FIG. 6 Environmental Regulation Template Motor Vehicle Air Conditioning Shop—Louisiana.

FIG. 7 Environmental Regulation Template Tire Shop—Louisiana.

FIG. 8 Environmental Regulation Template Dry Cleaner—Louisiana.

FIG. 9 Environmental Regulation Template Airport Screener—Louisiana.

FIG. 10 Environmental Regulation Template Convenience Store —Louisiana.

FIG. 11 Develop and Assign C-Records.

FIG. 12 Role of Internet Service Provider.

FIG. 13 Function of Facility Profile.

FIG. 14 Sign-In, Access and Completion of C-Records.

FIG. 15 Requirement to Maintain Perchloroethylene Purchase Records.

FIG. 16 Typical “Learn More” Page.

FIG. 17 Typical “See Text” Page.

FIG. 18 Typical “Take Test” Page.

FIG. 19 Monthly Perchloroethylene Purchase Log.

FIG. 20 Requirement for Hazardous Waste Contingency Plan C-Record.

FIG. 21 Facility Hazardous Waste Contingency Plan.

FIG. 22 Monitoring General Auditing and Compliance Status

FIG. 23 Get E-Mail Help From EHSforms

FIG. 24 Facility Convenience Store Attendant C-Record Completion Status Monitoring Screen.

FIG. 25 Single Louisiana Convenience Store —Store C-Record Completion Monitoring Status Screen.

FIG. 26 Multiple Commonly Owned Louisiana Convenience Store C-Record Completion Status Monitoring Screen.

FIG. 27 All Louisiana Convenience Stores C-Record Completion Status Monitoring Screen.

FIG. 28 All Major Facilities C-Record Completion Status Monitoring Screen.

VI. U.S. PATENTS CITED:

| | | |
|---|---|---|
| 4,803,039 | February 1989 | Implink, Jr., et al. |
| 5,247,661 | September 1993 | Hager, et al. |
| 5,276,869 | January 1994 | Forrest, et al. |
| 5,489,213 | February 1996 | Makipaa |
| 5,664,112 | September 1997 | Sturgeon, et al. |
| 5,640,577 | June 1997 | Scharmer |
| 5,726,884 | March 1998 | Sturgeon, et al. |
| 5,765,140 | June 1998 | Knudson, et al. |
| 5,774,887 | June 1998 | Wolff, et al. |
| 5,793,636 | August 1998 | Cooney, et al. |
| 5,813,009 | September 1998 | Johnson, et al. |
| 5,872,931 | February 1999 | Chivaluri |
| 5,893,070 | April 1999 | Garber, et al. |
| 5,897,619 | April 1999 | Hargrove, Jr., et al. |
| 6,029,144 | February 2000 | Barrett, et al. |
| 6,064,968 | May 2000 | Schanz |
| 6,067,549 | May 2000 | Smalley, et al. |
| 6,097,955 | August 2000 | Tipton, et al. |
| 6,122,622 | September 2000 | Wiitala, et al. |
| 6,151,586 | November 2000 | Brown |
| 6,163,2000 | December 2000 | Petke, et al. |
| 6,253,191 | June 2001 | Hoffman |
| 6,256,640 | July 2001 | Smalley, et al. |
| 6,292,806 | September 2001 | Sandifer |
| 6,302,165 | October 2001 | Nanaji, et al. |
| 6,321,204 | November 2001 | Kazami, et al. |
| 6,341,287 | January 2002 | Sziklai, et al. |
| 6,351,689 | February 2002 | Carr, et al. |
| 6,374,187 | April 2002 | Knight, et al. |
| 6,397,115 | May 2002 | Basden, et. Al. |
| 6,449,598 | September 2002 | Green. et al. |
| 6,460,042 | October 2002 | Hitchcock, et al. |
| 6,490,565 | December 2002 | Beldock |
| 6,546,314 | April 2003 | Carr, et al. |
| 6,557,009 | April 2003 | Singer, et al. |
| 6,571,158 | May 2003 | Sinex |
| 20020023109 | February 2002 | Lederer, et al. |
| 20020120642 | August 2002 | Fetherston, et al. |
| 20020138574 | September 2002 | Brown, et al. |
| 20020194014 | December 2002 | Starnes, et al |
| 20030065690 | April 2003 | Kelley, et al. |
| 20030069894 | April 2003 | Cotter, et al. |
| 20030083916 | May 2003 | Tracey, et al. |
| 20030120528 | June 2003 | Kruk, et al. |
| 20030113697 | June 2003 | Plescia, et al. |
| 20030115198 | June 2003 | Singer, et al. |
| 20030126002 | July 2003 | Jackson, et al. |
| 20030153991 | August 2003 | Visser, et al. |

### VII. OTHER REFERENCES CITED

Thomas, D. Jun. 7, 2000. Prepared Statement of Duncan Thomas, House Committee on Small Business, Hearing on Regulatory Reform Initiatives and Their Impact on Small Business. http://WWW.house.gov/smbiz/hearings/106th/2000/000,607/thomas.htm

Darien, K. May 15, 2003. Prepared Remarks of Ms. Kristie Darien, Director of Government Affairs, National Association for the Self Employed. House Committee on Small Business. “The Cost of Regulations to the Small Business Community”, (http:/WWW.house.gov/smbiz/hearings/108th/2003/030515/darien.html)

LDEQ Enforcement Summary —http://.WWW.deq.state.Ia.us/enforcement/enfactions-2001 q3.htm)

We claim:

1. A method to audit, comply and maintain on-going compliance at one or more specified commercial or retail facilities, with all applicable U.S. regulatory requirements promulgated by one or more state or federal regulatory agencies, capable of being predetermined from published state or federal codes of regulations, via the WWW, comprising:
means for identifying regulatory agency(ies) regulating the minor facility based upon information provided by a facility employee or contractor;
means for accessing appropriate state and federal government WWW web sites and databases containing state and federal regulations;
means for identifying specific regulations and regulatory requirements applicable to different minor facilities;
means for organizing applicable regulatory requirements into separate electronic checklist documents, (which might sometimes be referred to as C-Records”) each addressing one or more primary regulatory requirements, and each of which may be completed by a single employee or contractor;
means for formatting electronic checklist documents to include one or more detailed requirements, specific to each primary requirement each of which detailed requirements must be complied with, in order for a minor facility to be in compliance with a primary requirement;
means for incorporating an electronic link within each electronic checklist document providing access to additional information needed to help a employee—or contractor to better understand the primary and detailed regulatory requirements addressed by each electronic checklist document;
means for incorporating an electronic link within each electronic checklist document providing access to a copy of the text of regulatory requirements addressed by each electronic checklist document;
means for incorporating an electronic link within each electronic checklist document providing access to a quiz or a test on the regulatory requirements addressed in each electronic checklist document;
means for revising facility profiles to reflect changes in the construction and/or operation of the minor facility resulting in new compliance requirements
and means for automatically electronically notifying all responsible employees or contractors to confirm compliance with new requirements.
means for creating a single document for each employee and contractor position (that might sometimes be referred to as an “Audit Clipboard”) which may contain links to all electronic checklist documents to be completed by the individual working at the position;
means for creating a single document for each employee and contractor position (that might sometimes be referred to as an “Compliance Clipboard”) which may contain links to all electronic checklist documents to be completed by the individual working at the position;
means for prompting a minor facility employee or contractor to identify a specified facility type;
means for prompting a minor facility employee or contractor to identify the city, town, county (or parish) and state in which the facility operates;
means for prompting a minor facility employee or contractor to complete an electronic checklist providing more detailed information on entity operations as needed to identify all specific regulated activities undertaken by the minor facility;
means for storing electronic checklist documents within a facility database residing on a server maintained by a service provider;
means for prompting a minor facility employee or contractor to assign audit and compliance responsibilities to various employees or contractors, and direct employees and contractors to audit, comply and confirm compliance by completing assigned electronic checklist documents;
means for prompting various responsible employees and contractors at a minor facility to access assigned electronic checklist documents, and read additional information about regulatory requirements linked to each electronic checklist document;
means for prompting various responsible employees and contractors at a facility to access assigned electronic checklist documents, and view the actual text of regulatory requirements linked to each electronic checklist document;
means for prompting various responsible employees and contractors at a facility to access electronic checklist documents, and take a test to confirm understanding of regulatory requirements linked to each electronic checklist document;
means for scoring, storing and displaying test results;
means for requiring a minor facility employee or contractor to receive a pre-established test score before being permitted to complete and submit an electronic checklist document;
means for prompting employees and contractors to audit facility compliance with primary requirements and detailed requirements by accessing and checking appropriate locations in each assigned electronic checklist document;
means for identifying employees and contractors that have timely completed and submitted all electronic checklist audit documents;
means for identifying employees and contractors that have failed to timely complete and submit one or more electronic checklist audit documents;
means for identifying employees and contractors failing to confirm compliance with one or more primary requirements when submitting an electronic checklist audit document;
means for storing and displaying minor facility audit results,
means for allowing an authorized employee or contractor to view minor facility audit results via an intranet or the WWW;
means for prompting employees and contractors at each minor facility to access, and confirm on-going facility compliance with primary requirements and detailed requirements by checking appropriate places in each assigned electronic checklist document and submit same to the minor facility database;
means for identifying employees and contractors that have timely completed and submitted all electronic checklist ongoing compliance documents;
means for identifying employees and contractors that have failed to timely complete and submit one or more electronic checklist compliance documents;
means for identifying employees and contractors failing to confirm compliance with one or more primary requirements when submitting an electronic checklist compliance document;
means for storing and displaying facility compliance results;
means for allowing an authorized individual to view facility employee, contractor or facility compliance status and results via the WWW.

2. The method of claim 1 where the specified facility type is selected from a list, comprising: automobile dealerships; heating, ventilating and air conditioning contractors; chiropractor, physician and dental offices; hospitals; motor vehicle paint and body shops; motor vehicle air conditioning shops; motor vehicle tire shops; dry cleaners; nursing homes; passenger airports; cargo airports; private airports; animal hospitals; banks; funeral homes; motorcycle dealers; recreational vehicle dealers; painting contractors; pest control contractors; gasoline stations; convenience stores; private and municipal motor vehicle repair and maintenance shops; radiator repair shops; brake repair shops, muffler and exhaust shops; oil and motor vehicle oil and lubrication shops; motor vehicle windshield repair shops; restaurants; fast food establishments; hotels; motels; private and local, state and federal office buildings; private and municipal drinking water treatment plants, private and municipal wastewater treatment plants.

3. The method of claim 1 wherein the regulatory requirements applicable to the minor facility derive from regulations promulgated by a federal regulatory agency and published in the U.S. Code of Federal Regulations.

4. The method of claim 1 wherein the regulatory requirements applicable to a minor facility derive from regulations promulgated by a state regulatory agency and published in an appropriate state administrative code.

5. The method of claim 1 wherein the individual authorized to view the employee, contractor, and/or facility compliance status is a manager, director or officer of the facility.

6. The method of claim 1 wherein the individual authorized to view the employee, contractor, and/or facility compliance status is an attorney and/or law firm, retained by the facility to provide legal advice concerning compliance.

7. The method of claim 1 wherein the individual authorized to view the employee, contractor, and/or facility compliance status is a regulatory agency charged with responsibility for regulating the facility.

8. The method of claim 1 wherein the individual authorized to view the employee, contractor, and/or facility compliance status is a bank or an insurance company or an insurance broker contemplating issuance of an insurance policy to the owners and/or operators of the facility.

9. A method to audit, comply and maintain on-going compliance at one or more specified facilities with all applicable U.S. regulatory agency reporting requirements promulgated by one or more state or federal regulatory agencies, capable of being predetermined from published state or federal codes of regulations, via the WWW, comprising:
means for identifying regulatory agency(ies) regulating the facilities, based upon information provided by a facility employee or contractor;
means for accessing appropriate state and federal government WWW web sites and databases containing state and federal regulations;
means for identifying specific regulations and regulatory reporting requirements applicable to facilities;
means for organizing regulatory reporting requirements into separate electronic checklist documents, (which might sometimes be referred to as C-Records”) each addressing one or more primary regulatory requirements, and each of which may be completed by a single employee or contractor;
means for incorporating an electronic link within each electronic checklist document providing access to additional information needed to help a employee or contractor to better understand reporting requirements addressed by each electronic checklist document;
means for incorporating an electronic link within each electronic checklist document providing access to a copy of the text of regulatory requirements addressed by each electronic checklist document;
means for incorporating an electronic link within each electronic checklist document providing access to a quiz or a test on the regulatory requirements addressed in each electronic checklist document;
means for revising facility profiles to reflect changes in the construction and/or operation of the major facility resulting in new compliance requirements
and means for automatically electronically notifying all responsible employees or contractors to confirm compliance with new requirements.
means for creating a single document for each employee and contractor position (that might sometimes be referred to as an “Audit Clipboard”) which may contain links to all electronic checklist documents to be completed by the individual working at the position;
means for creating a single document for each employee and contractor position (that might sometimes be referred to as an “Compliance Clipboard”) which may contain links to all electronic checklist documents to be completed by the individual working at the position;
means for prompting a major facility employee or contractor to identify a specified facility type;
means for prompting a minor facility employee or contractor to identify the city, town, county (or parish) and state in which the facility operates;
means for prompting a minor facility employee or contractor to complete an electronic checklist providing more detailed information on entity operations as needed to identify all reporting requirements applicable to the facility;
means for storing electronic checklist documents within a facility database residing on a server maintained by a service provider;
means for prompting a facility employee or contractor to assign audit and compliance responsibilities to various employees or contractors, and direct employees and contractors to audit, comply and confirm compliance by completing assigned electronic checklist documents;
means for prompting various responsible employees and contractors at a minor facility to access assigned electronic checklist documents, and read additional information about regulatory reporting requirements linked to each electronic checklist document;
means for prompting various responsible employees and contractors at a facility to access assigned electronic checklist documents, and view the actual text of regulatory requirements linked to each electronic checklist document;
means for prompting various responsible employees and contractors at a facility to access electronic checklist documents, and take a test to confirm understanding of regulatory reporting requirements linked to each electronic checklist document;
means for scoring, storing and displaying test results;
means for requiring a minor facility employee or contractor to receive a pre-established test score before being permitted to complete and submit an electronic checklist document;
means for prompting employees and contractors to audit facility compliance with reporting requirements by accessing and checking appropriate locations in each assigned electronic checklist document;
means for identifying employees and contractors that have timely completed and submitted all electronic checklist audit documents;
means for identifying employees and contractors that have failed to timely complete and submit one or more electronic checklist audit documents;
means for identifying employees and contractors failing to confirm compliance with one or more reporting requirements when submitting an electronic checklist audit document;
means for storing and displaying minor facility audit results;
means for allowing an authorized employee or contractor to view major facility audit results via an intranet or the WWW;
means for prompting employees and contractors at each facility to access, and confirm on-going facility compliance with reporting requirements by checking appropriate places in each assigned electronic checklist document and submit same to the minor facility database;
means for identifying employees and contractors that have timely completed and submitted all electronic checklist on-going compliance documents;
means for identifying employees and contractors that have failed to timely complete and submit one or more electronic checklist compliance documents;
means for identifying employees and contractors failing to confirm compliance with one or more reporting requirements when submitting an electronic checklist compliance document;
means for storing and displaying facility compliance results;
means for allowing an authorized individual to view facility employee, contractor or facility compliance status and results via the WWW.

10. The method of claim 9 where the facility type is selected from a Standard Industry Classification (“SIC”) list published by the United states Government or any alternate list subsequently intended to substitute for any such SIC list in the future.

11. The method of claim 9 wherein the regulatory requirements applicable to the facility derive from regulations promulgated by a federal regulatory agency and published in the U.S. Code of Federal Regulations.

12. The method of claim 9 wherein the regulatory requirements applicable to the facility derive from regulations promulgated by a state regulatory agency and published in an appropriate state administrative code.

13. The method of claim 9 wherein the individual authorized to view the employee, contractor, and/or facility compliance status is a manager, director or officer of the facility.

14. The method of claim 9 wherein the individual authorized to view the employee, contractor, and/or facility compliance status is an attorney and/or law firm, retained by the facility to provide legal advice concerning compliance.

15. The method of claim 9 wherein the individual authorized to view the employee, contractor, and/or facility compliance status is a regulatory agency charged with responsibility for regulating the facility.

16. The method of claim 9 wherein the individual authorized to view the employee, contractor, and/or facility compliance status is a bank or an insurance company or an insurance broker contemplating issuance of an insurance policy to the owners and/or operators of the facility.
